(19) United States
(12) Patent Application Publication
(10) Pub. No.: US 2021/0033712 A1
(43) Pub. Date: Feb. 4, 2021

(54) CALIBRATION APPARATUS, CALIBRATION METHOD, AND PROGRAM

(71) Applicant: SONY CORPORATION, TOKYO (JP)

(72) Inventors: SEUNGHA YANG, KANAGAWA (JP); SUGURU AOKI, TOKYO (JP); RYUTA SATOH, KANAGAWA (JP)

(21) Appl. No.: 16/964,906

(22) PCT Filed: Nov. 16, 2018
(86) PCT No.: PCT/JP2018/042448

§ 371 Date: Jul. 24, 2020

(30) Foreign Application Priority Data
Feb. 9, 2018 (JP) 2018-021494

(51) Int. Cl. G01S 7/497; G01S 17/89; G01S 17/50

(52) U.S. Cl. CPC G01S 7/497; G01S 17/50; G01S 17/89

(57) ABSTRACT

Information acquisition units 11-1 and 11-2 (11-2a) acquire peripheral object information, and information processing units 12-1 and 12-2 (12-2a) generate point cloud data relating to a feature point of a peripheral object on the basis of the peripheral object information. A weight setting unit 13 sets a weight according to a situation between the peripheral object and the information acquisition units when the peripheral object information was acquired. A calibration processing unit 15 uses the point cloud data, the weight, and external parameters stored in a parameter storage unit 14 to calculate new external parameters that minimize an error of the external parameters, on the basis of a cost indicating the error. A parameter update unit 16 updates the external parameters stored in the parameter storage unit 14 using the calculated new external parameters. Since highly accurate external parameters are stored in the parameter storage unit 14, the calibration can be performed stably.

### TECHNICAL FIELD

This technology relates to a calibration apparatus, a calibration method, and a program, and allows calibration to be performed stably.

### BACKGROUND ART

Conventionally, an object in a peripheral area is recognized using a ranging apparatus. For example, in Patent Document 1, a moving body is provided with a distance measuring sensor that measures a distance to a structure and a sensor position measuring apparatus that measures a three-dimensional position of the distance measuring sensor, and a three-dimensional position of the structure is calculated using a measurement result of the distance measuring sensor and a measurement result of the sensor position measuring apparatus. Furthermore, calibration is performed for the mounting position and mounting attitude of the distance measuring sensor.

### CITATION LIST

### Patent Document

Patent Document 1: Japanese Patent Application Laid-Open No. 2011-027598

### SUMMARY OF THE INVENTION

### Problems to be Solved by the Invention

Incidentally, a sensor used for recognizing an object in a peripheral area is not restricted to the distance measuring sensor indicated in Patent Document 1. For example, three-dimensional measurement or the like is performed using an imaging apparatus on the basis of a captured image acquired by the imaging apparatus. In three-dimensional measurement based on the captured image, for example, three-dimensional measurement is performed by utilizing the principle of triangulation in line with captured images acquired by two imaging apparatuses whose relative positions and attitudes are known. Furthermore, in order to enhance the reliability of three-dimensional measurement, not only the imaging apparatus but also a ranging apparatus is used. As described above, in order to perform three-dimensional measurement using a plurality of imaging apparatuses or an imaging apparatus and a ranging apparatus, the relative positions and attitudes between the imaging apparatuses or between the imaging apparatus and the ranging apparatus need to be calibrated beforehand. However, in a case where the calibration is performed using point cloud data acquired by the ranging apparatus and point cloud data based on a feature point detected from the captured image, there is a possibility that the image of a foreground object is blurred when a distant object is focused, or a possibility that the ranging accuracy of the ranging apparatus deteriorates as the object becomes distant. Therefore, the calibration cannot be performed stably. In addition, if the imaging apparatus and the ranging apparatus are not synchronized, a difference between the positions of observation points sometimes increases in a case where the moving speed is higher, and the calibration cannot be performed stably.

Thus, an object of this technology is to provide a calibration apparatus, a calibration method, and a program capable of performing the calibration stably.

### Solutions to Problems

A first aspect of this technology is

a calibration apparatus including

a calibration processing unit that calculates parameters relating to positions and attitudes of a plurality of information acquisition units, using point cloud data relating to a feature point of a peripheral object generated on the basis of peripheral object information acquired by the plurality of information acquisition units, and a weight according to a situation between the peripheral object and the information acquisition units when the peripheral object information was acquired.

In this technology, the plurality of information acquisition units acquires the peripheral object information a plurality of times in a predetermined period, for example, in a preset period from a start of movement of a moving body provided with the plurality of information acquisition units or a preset period until an end of movement of the moving body. Furthermore, the plurality of information acquisition units is configured to each acquire at least a captured image of the peripheral object as the peripheral object information. For example, the information acquisition units are constituted by a plurality of information acquisition units that each acquires a captured image of the peripheral object, or an information acquisition unit that acquires a captured image of the peripheral object and an information acquisition unit that quantifies a distance to each position of the peripheral object using a ranging sensor to treat a quantification result as the peripheral object information. An information processing unit performs a registration process on the quantification result for a distance to each position of the peripheral object acquired by the information acquisition unit, and generates point cloud data for each position of the peripheral object as point cloud data for each feature point. In addition, the information processing unit performs feature point detection using a captured image of the peripheral object acquired by the information acquisition unit, and generates point cloud data for each feature point by a registration process for the detected feature point of the peripheral object.

The calibration processing unit calculates new external parameters using the point cloud data relating to the feature point of the peripheral object, the weight relating to a situation between the peripheral object and the information acquisition units when the peripheral object information was acquired, and the parameters (external parameters) relating to positions and attitudes of the plurality of information acquisition units stored in advance. As the weight relating to a situation between the peripheral object and the information acquisition units, relative speed and distance between the peripheral object and the information acquisition units, and a motion vector of the feature point are used. The calibration processing unit sets the weight according to a moving speed of a moving body provided with the plurality of information acquisition units for each acquisition of the peripheral object information, and reduces the weight as the moving speed increases. Furthermore, the calibration processing unit sets the weight according to a distance between the peripheral object and each of the information acquisition units, and reduces the weight as the distance increases. Moreover, in setting the weight, the weight is set according to the motion vector of the feature point, and the weight is reduced as the motion vector increases. The calibration processing unit calculates a cost indicating an error of the parameters for each acquisition of the peripheral object information, using the weight, the point cloud data, and the parameters stored in advance, and calculates new parameters that minimize the error, on the basis of an accumulated value of the cost for each acquisition. Additionally, a parameter update unit updates the stored parameters to the parameters calculated by the calibration processing unit from when movement of a moving body provided with the plurality of information acquisition units is stopped or when movement of the moving body ends until when movement of the moving body starts next time.

A second aspect of this technology is

a calibration method including

calculating, by a calibration processing unit, parameters relating to positions and attitudes of a plurality of information acquisition units, using point cloud data relating to a feature point of a peripheral object generated on the basis of peripheral object information acquired by the plurality of information acquisition units, and a weight according to a situation between the peripheral object and the information acquisition units when the peripheral object information was acquired.

A third aspect of this technology is

a program for performing calibration on a computer,

the program causing the computer to execute:

a procedure of acquiring point cloud data relating to a feature point of a peripheral object generated on the basis of peripheral object information acquired by a plurality of information acquisition units; and

a procedure of calculating parameters relating to positions and attitudes of the plurality of information acquisition units, using a weight according to a situation between the peripheral object and the information acquisition units when the peripheral object information was acquired.

Note that the program according to the present technology is a program that can be provided, for example, to a general-purpose computer capable of executing a variety of program codes by a storage medium or a communication medium that provides a program in a computer-readable format, for example, a storage medium such as an optical disc, a magnetic disk, and a semiconductor memory or a communication medium such as a network. By providing such a program in a computer-readable format, a process according to the program is implemented on the computer.

### Effects of the Invention

According to this technology, external parameters between a plurality of information acquisition units are calculated using point cloud data relating to a feature point of a peripheral object generated on the basis of peripheral object information acquired by the plurality of information acquisition units, and a weight according to a situation between the peripheral object and the information acquisition units when the peripheral object information was acquired. Consequently, the calibration is allowed to be performed stably. Note that the effects described in the present description merely serve as examples and not construed to be limited. There may be an additional effect as well.

### BRIEF DESCRIPTION OF DRAWINGS

FIG. 1 is a diagram exemplifying a configuration of a calibration apparatus.

FIG. 2 is a diagram exemplifying a configuration of a first embodiment.

FIG. 3 is a diagram exemplifying a relationship between a speed and a weight.

FIG. 4 is a diagram exemplifying feature points.

FIG. 5 is a flowchart exemplifying working of the first embodiment.

FIG. 6 is a diagram illustrating a working example of the first embodiment.

FIG. 7 is a diagram exemplifying a configuration of a second embodiment.

FIG. 8 is a diagram exemplifying a relationship between a distance and a weight.

FIG. 9 is a flowchart exemplifying working of the second embodiment.

FIG. 10 is a diagram illustrating a working example of the second embodiment.

FIG. 11 is a diagram exemplifying a configuration of a third embodiment.

FIG. 12 is a diagram exemplifying a relationship between a magnitude of a motion vector and a weight.

FIG. 13 is a flowchart exemplifying working of the third embodiment.

FIG. 14 is a diagram exemplifying a configuration of a fourth embodiment.

FIG. 15 is a flowchart exemplifying working of the fourth embodiment.

FIG. 16 is a diagram exemplifying a configuration of a fifth embodiment.

FIG. 17 is a flowchart exemplifying working of the fifth embodiment.

FIG. 18 is a diagram exemplifying a configuration of a sixth embodiment.

FIG. 19 is a flowchart exemplifying working of the sixth embodiment.

FIG. 20 is a block diagram illustrating an example of a schematic configuration of a vehicle control system.

FIG. 21 is an explanatory diagram illustrating an example of installation positions of vehicle exterior information detecting parts and imaging units.

### MODE FOR CARRYING OUT THE INVENTION

Hereinafter, modes for carrying out the present technology will be described. Note that the description will be given in the following order.

1. Configuration of Calibration Apparatus

2. First Embodiment

3. Second Embodiment

4. Third Embodiment

5. Fourth Embodiment

6. Fifth Embodiment

7. Sixth Embodiment

8. Other Embodiments

9. Application Examples

### 1. Configuration of Calibration Apparatus

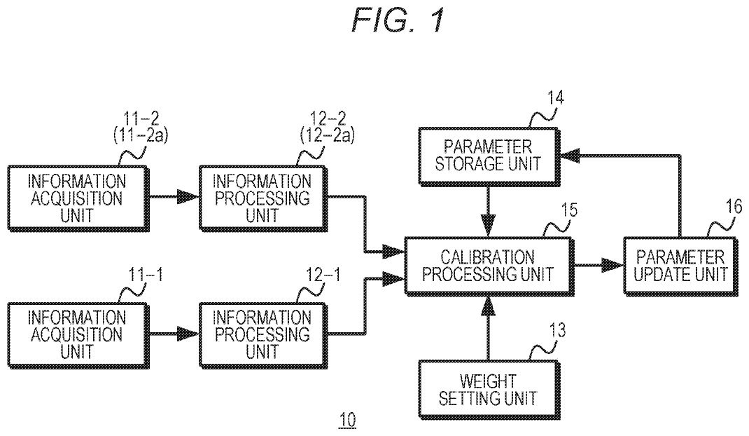

FIG. 1 exemplifies a configuration of a calibration apparatus according to the present technology. The calibration apparatus 10 is configured using a plurality of information acquisition units 11-1 and 11-2 (2a) and information processing units 12-1 and 12-2 (2a), a weight setting unit 13, a parameter storage unit 14, a calibration processing unit 15, and a parameter update unit 16. Note that the calibration apparatus 10 is not restricted to a case where the blocks illustrated in FIG. 1 are provided as a unified body, but may have a configuration in which some blocks are provided separately.

The information acquisition units 11-1 and 11-2 (2a) acquire peripheral object information. The peripheral object information is information that enables the acquisition of information regarding a feature point of a peripheral object, and is, for example, a captured image in which a peripheral object is imaged, ranging data to each position of a peripheral object, or the like. The information processing unit 12-1 generates point cloud data of feature points in the peripheral object on the basis of the peripheral object information acquired by the information acquisition unit 11-1, and outputs the generated point cloud data to the calibration processing unit 15. Similarly, the information processing unit 12-2 (2a) generates point cloud data of feature points in the peripheral object on the basis of the peripheral object information acquired by the information acquisition unit 11-2 (2a), and outputs the generated point cloud data to the calibration processing unit 15.

The weight setting unit 13 sets a weight according to a situation between the peripheral object and the information acquisition units, which affects the accuracy of the calibration. The weight setting unit 13 outputs the set weight to the calibration processing unit 15.

The parameter storage unit 14 holds parameters (hereinafter, referred to as “external parameters”) relating to the positions and attitudes of the plurality of information acquisition units. The parameter storage unit 14 outputs the held external parameters to the calibration processing unit 15. Furthermore, in a case where external parameters are supplied from the parameter update unit 16, the parameter storage unit 14 updates the held external parameters to the external parameters supplied from the parameter update unit 16.

The calibration processing unit 15 calculates a cost according to an error of the external parameters on the basis of a cost function, using the point cloud data for a predetermined period supplied from the information processing units 12-1 and 12-2 (2a), the weight set by the weight setting unit 13, and the external parameters acquired from the parameter storage unit 14. Furthermore, the calibration processing unit 15 calculates new external parameters that minimize the accumulated value of the cost for the predetermined period, and outputs the calculated new external parameters to the parameter update unit 16.

The parameter update unit 16 outputs the new external parameters calculated by the calibration processing unit 15 to the parameter storage unit 14, such that the parameter storage unit 14 holds the external parameters that allow the calibration to be performed stably.

### 2. First Embodiment

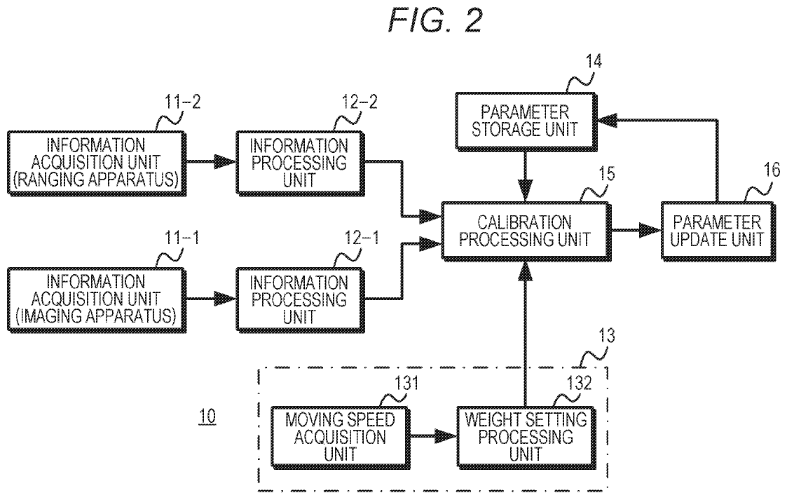

Next, a first embodiment will be described. FIG. 2 exemplifies a configuration of the first embodiment. In the first embodiment, two information acquisition units 11-1 and 11-2 are used. The information acquisition unit 11-1 is configured using an imaging apparatus so as to acquire a captured image. The information acquisition unit 11-2 is configured using a ranging apparatus, for example, a time-of-flight (TOF) camera, light detection and ranging or laser imaging detection and ranging (LIDAR), or the like, and acquires point cloud data indicating a ranging value. Furthermore, a weight setting unit 13 sets a weight according to a situation between a peripheral object and the information acquisition units. The weight setting unit 13 uses a moving speed as a situation between the peripheral object and the information acquisition units. Here, the moving speed is, for example, assumed as a moving speed of the information acquisition units 11-1 and 11-2 with respect to the peripheral object.

The information acquisition unit 11-1 outputs the acquired captured image to an information processing unit 12-1, and the information acquisition unit 11-2 outputs the acquired point cloud data to an information processing unit 12-2.

The information processing unit 12-1 performs a structure from motion (SfM) process. In the SfM process, point cloud data for each feature point, for example, point cloud data indicating the distance for each feature point, is generated by a registration process for feature points of the peripheral object detected from a plurality of captured images in chronological order acquired by the information acquisition unit 11-1. The information processing unit 12-1 outputs the generated point cloud data to a calibration processing unit 15.

The information processing unit 12-2 performs the registration process on a quantification result for a distance to each position of the peripheral object acquired by the information acquisition unit 11-1, and generates point cloud data for each position of the peripheral object as point cloud data for each feature point to output the generated point cloud data to the calibration processing unit 15.

The weight setting unit 13 includes a moving speed acquisition unit 131 and a weight setting processing unit 132. The moving speed acquisition unit 131 is configured using a sensor or the like capable of detecting the moving speed of a moving body. For example, in a case where the moving body is a vehicle, the moving speed acquisition unit 131 is configured using a vehicle speed detection sensor, and outputs speed information indicating the detected moving speed to the weight setting processing unit 132.

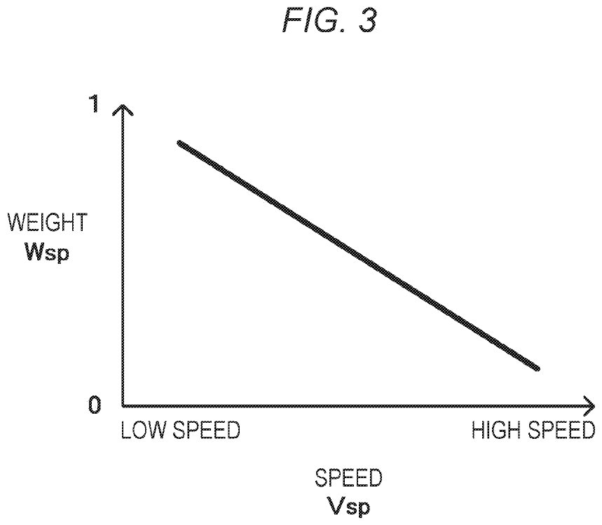

The weight setting processing unit 132 sets the weight according to the moving speed acquired by the moving speed acquisition unit 131. Here, in a case where the information acquisition units 11-1 and 11-2 acquire the captured image and the point cloud data asynchronously, there is a case where the position of the peripheral object has a larger difference between a position indicated by the captured image and a position indicated by the point cloud data when the moving speed increases. Thus, the weight setting processing unit 132 reduces the weight as the moving speed increases. FIG. 3 exemplifies a relationship between a speed and a weight, and the weight setting processing unit 132 sets a weight Wsp according to a moving speed Vsp that has been acquired, and outputs the set weight Wsp to the calibration processing unit 15.

The parameter storage unit 14 stores, for example, external parameters between the information acquisition units 11-1 and 11-2, and the stored external parameters can be updated by the parameter update unit 16.

The calibration processing unit 15 performs registration of the point cloud data for a predetermined period supplied from the information processing units 12-1 and 12-2, and treats the point cloud data of the same feature point as data of an identical coordinate system. Moreover, the calibration processing unit 15 uses the point cloud data after the registration, the weight set by the weight setting unit 13, and the external parameters stored in the parameter storage unit 14 to calculate new external parameters that minimize the accumulated value of the cost for the predetermined period. For example, in a case where the information acquisition units 11-1 and 11-2 are provided in a vehicle, the predetermined period is assumed as a preset period from the start of running of the vehicle. Furthermore, the predetermined period may be a preset period until the end of running of the vehicle.

Here, the post-registration data of the point cloud data supplied from the information processing unit 12-1 is referred to as point cloud data Ca(i, t), and the post-registration data of the point cloud data supplied from the information processing unit 12-2 is referred to as point cloud data L(i, t). Note that “t” denotes an index relating to time (hereinafter referred to as “time index”), and “i” denotes an index relating to a feature point (hereinafter referred to as “feature point index”). Furthermore, the external parameters are assumed as a translation parameter T and a rotation parameter R. Note that the translation parameter T is a parameter relating to the positions of the information acquisition units 11-1 and 11-2, whereas the rotation parameter R is a parameter relating to the attitudes of the information acquisition units 11-1 and 11-2.

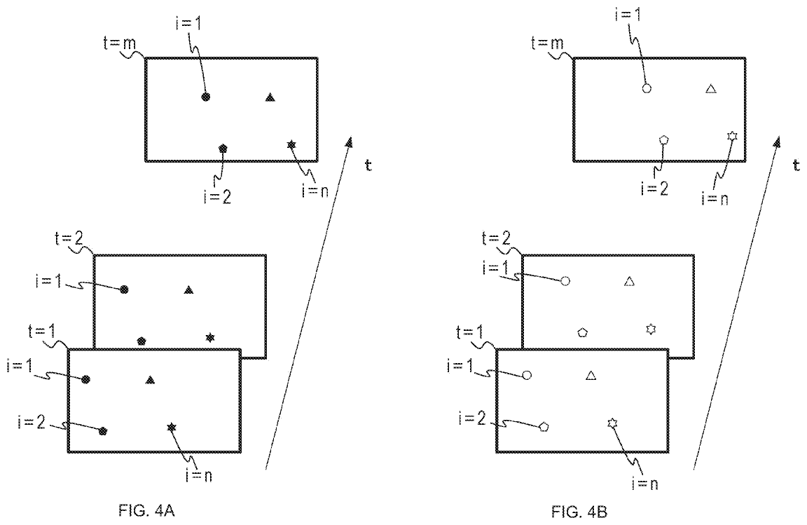

FIG. 4 exemplifies feature points, where (a) of FIG. 4 exemplifies feature points acquired by the information acquisition unit 11-1, and (b) of FIG. 4 exemplifies feature points acquired by the information acquisition unit 11-2. The feature points are acquired at times corresponding to time indexes t=1 to m. Furthermore, for example, feature points indicated by feature point indexes i=1 to n are acquired as the feature points. Moreover, the corresponding feature points between the time indexes are assumed to have an equal value of the feature point index i.

The calibration processing unit 15 calculates a cost E on the basis of Formula (1), using a weight Wsp(t) for each time index set by the weight setting unit 13. Additionally, the calibration processing unit 15 calculates a translation parameter T and a rotation parameter R that minimize the calculated cost E. The calibration processing unit 15 outputs the translation parameter T and the rotation parameter R that minimize the cost E, to the parameter update unit 16.

[Mathematical Formula 1]

E=Σ_{t∈m}(wₛₚ₍ₜ₎Σ_{i∈n}∥RCa_{(i,t)}+T−L_{(i,t)}∥²) (1)

The parameter update unit 16 updates the external parameters (the translation parameter and the rotation parameter) stored in the parameter storage unit 14 at a predetermined timing, using the translation parameter T and the rotation parameter R supplied from the calibration processing unit 15. For example, it is assumed that the information acquisition units 11-1 and 11-2 are provided in a vehicle, and new external parameters are calculated using peripheral object information acquired during a predetermined period preset from the start of running of the vehicle. In this case, the external parameters stored in the parameter storage unit 14 are updated with the newly calculated external parameters at a timing when the vehicle is put into a stop state thereafter. Furthermore, it is assumed that new external parameters are calculated using peripheral object information acquired during a predetermined period preset until the end of running of the vehicle. In this case, since the vehicle is in a running end state, the external parameters stored in the parameter storage unit 14 are updated with the newly calculated external parameters immediately or during a period until the next start of running.

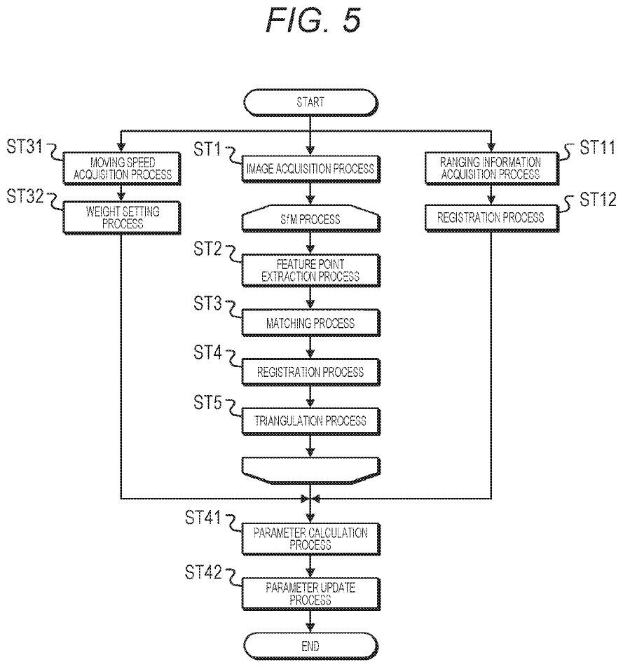

FIG. 5 is a flowchart exemplifying working of the first embodiment. In step ST1, a calibration apparatus performs an image acquisition process. The information acquisition unit 11-1 of the calibration apparatus acquires a captured image as peripheral object information, and proceeds to step ST2.

In step ST2, the calibration apparatus performs a feature point detection process in the SfM process. The information processing unit 12-1 of the calibration apparatus detects a feature point (for example, an edge, a corner, or the like) representing a feature of the image from the captured image acquired in step ST1, and proceeds to step ST3.

In step ST3, the calibration apparatus performs a matching process. The information processing unit 12-1 of the calibration apparatus performs the matching process for feature points between captured images having different imaging times to detect which feature point in the captured image corresponds to which feature point in another captured image, and proceeds to step ST4.

In step ST4, the calibration apparatus performs a registration process. The information processing unit 12-1 of the calibration apparatus detects a positional relationship on the image between corresponding feature points on the basis of a detection result in step ST3, and proceeds to step ST5.

In step ST5, the calibration apparatus performs a triangulation process. The information processing unit 12-1 of the calibration apparatus calculates a distance to a feature point by utilizing a positional relationship on the image of feature points matching between captured images having different imaging times. Furthermore, the information processing unit 12-1 treats the distance for each feature point as point cloud data, and proceeds to step ST41. Note that the SfM process is not restricted to the processes from step ST2 to step ST5, and may include a process not illustrated, such as vandal adjustment, for example.

In step ST11, the calibration process performs a ranging information acquisition process. The information acquisition unit 11-2 of the calibration apparatus acquires, as peripheral object information, point cloud data indicating a ranging result for each point in an imaging range by the information acquisition unit 11-1, and proceeds to step ST12.

In step ST12, the calibration apparatus performs a registration process. The information processing unit 12-2 of the calibration apparatus detects point cloud data of a corresponding point from the point cloud data for each time obtained in step ST11, and proceeds to step ST41.

In step ST31, the calibration apparatus performs a moving speed acquisition process. The weight setting unit 13 of the calibration apparatus includes the moving speed acquisition unit 131 and the weight setting processing unit 132. The moving speed acquisition unit 131 acquires, for example, from a vehicle speed detection sensor, speed information indicating the moving speed of a moving body provided with the information acquisition units 11-1 and 11-2, and proceeds to step ST32.

In step ST32, the calibration apparatus performs a weight setting process. The weight setting unit 13 of the calibration apparatus sets a weight on the basis of the speed information acquired in step ST31, and proceeds to step ST41.

In step ST41, the calibration apparatus performs a parameter calculation process. The calibration processing unit 15 of the calibration apparatus determines a correspondence between the point cloud data obtained in the processes in steps ST1 to ST5 and the point cloud data obtained in the processes in steps ST11 and ST12, and as indicated by above Formula (1), calculates the cost using the corresponding pieces of point cloud data and the weight set in step ST32. Furthermore, the calibration processing unit 15 calculates the external parameters, that is, the translation parameter T and the rotation parameter R that minimize the accumulated value of the cost for the predetermined period, and proceeds to step ST42.

In step ST42, the calibration apparatus performs a parameter update process. The parameter update unit 16 of the calibration apparatus updates the external parameters stored in the parameter storage unit 14 using the translation parameter T and the rotation parameter R calculated in step ST41.

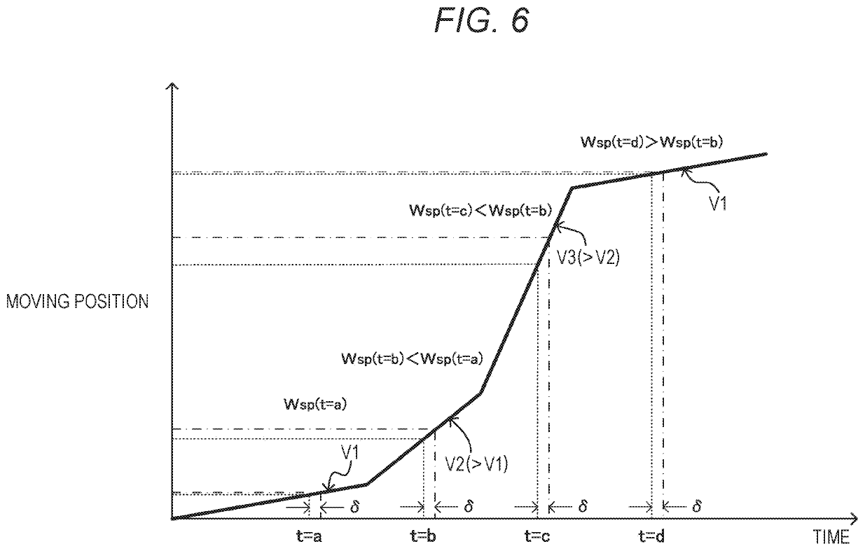

According to such a first embodiment, the weight for the cost is reduced for a section where the moving speed is higher. FIG. 6 is a diagram illustrating a working example of the first embodiment. For example, in a case where the information acquisition units 11-1 and 11-2 are fixed to a side surface of a moving body in an equal orientation, a change in position of the feature point is smaller when the moving speed of the moving body in a forward direction is lower, but if the moving speed is higher, a change in position of the feature point is larger. Therefore, in a case where a difference δ is produced between a timing at which the information acquisition unit 11-1 acquires a captured image and a timing at which the information acquisition unit 11-2 acquires peripheral object information, a difference in positions between feature points is smaller when the moving speed is lower, but as the moving speed increases, a difference in positions between feature points increases. For this reason, weights Wsp (t=a) and Wsp (t=d) of time indexes t=a and t=d when the moving speed is a speed V1, which is a low speed, are made larger than a weight Wsp (t=b) of a time index t=b when the moving speed is a speed V2 (V1<V2), which is a medium speed. Furthermore, a weight Wsp (t=c) of a time index t=c when the moving speed is a speed V3 (V2<V3), which is a high speed, is made smaller than the weight Wsp (t=b).

As described above, according to the first embodiment, the weight is reduced as the moving speed increases, such that the influence of an error in observation points (a difference in positions between observation points) in calibration can be lowered. Accordingly, the calibration can be performed with higher accuracy and stability than a case where the calibration is performed without using the weight according to the speed.

### 3. Second Embodiment

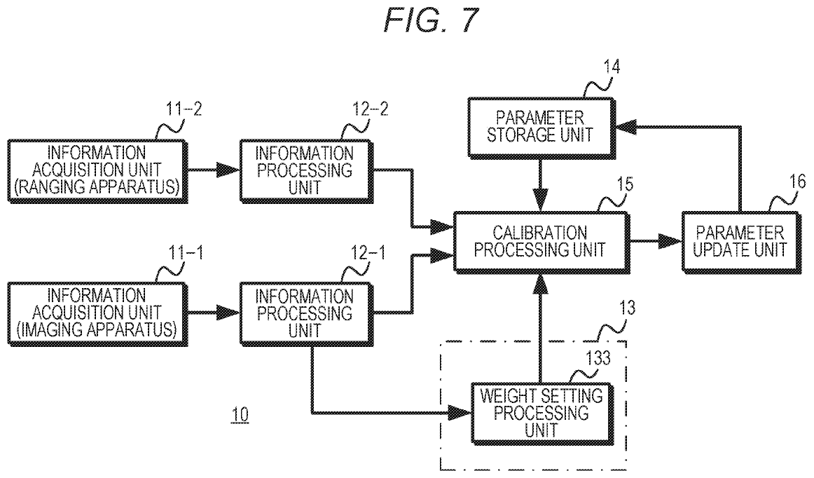

Next, a second embodiment will be described. FIG. 7 exemplifies a configuration of the second embodiment. In the second embodiment, two information acquisition units 11-1 and 11-2 are used. The information acquisition unit 11-1 is configured using an imaging apparatus so as to acquire a captured image. The information acquisition unit 11-2 is configured using a ranging apparatus, for example, a time-of-flight (TOF) camera, light detection and ranging or laser imaging detection and ranging (LIDAR), or the like, so as to acquire point cloud data indicating a ranging value. Furthermore, a weight setting unit 13 uses a distance as a situation between the peripheral object and the information acquisition units. Here, the distance is, for example, assumed as a distance to each point of the peripheral object.

The information acquisition unit 11-1 outputs the acquired captured image to an information processing unit 12-1, and the information acquisition unit 11-2 outputs the acquired point cloud data to an information processing unit 12-2.

The information processing unit 12-1 performs the structure from motion (SfM) process, and generates point cloud data for each feature point detected from a plurality of captured images in chronological order acquired by the information acquisition unit 11-1 to output the generated point cloud data to a calibration processing unit 15. Furthermore, the information processing unit 12-1 outputs the distance for each feature point to the weight setting unit 13.

The information processing unit 12-2 performs the registration process on a quantification result for a distance to each position of the peripheral object acquired by the information acquisition unit 11-1, and generates point cloud data for each position of the peripheral object as point cloud data for each feature point to output the generated point cloud data to the calibration processing unit 15.

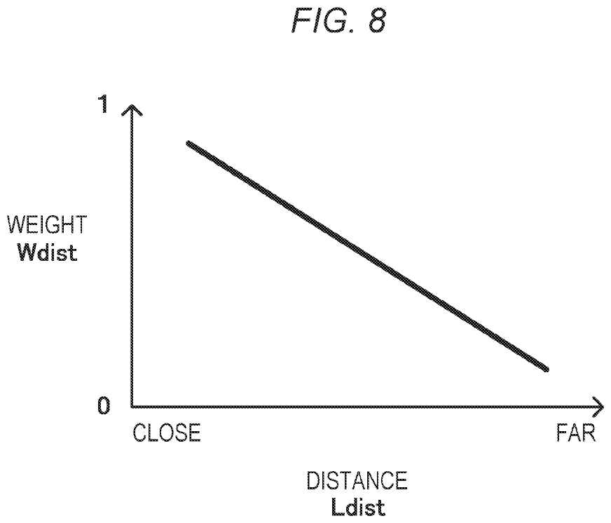

The weight setting unit 13 includes a weight setting processing unit 133. The weight setting processing unit 133 sets a weight according to the distance for each feature point acquired from the information processing unit 12-1. Here, since there is a possibility that the ranging accuracy is deteriorated when the distance increases, the weight setting processing unit 133 reduces the weight as the distance increases. FIG. 8 exemplifies a relationship between a distance and a weight, and the weight setting processing unit 133 sets a weight Wdist according to a distance Ldist that has been acquired, and outputs the set weight Wdist to the calibration processing unit 15.

A parameter storage unit 14 stores, for example, external parameters between the information acquisition units 11-1 and 11-2, and the stored external parameters can be updated by a parameter update unit 16.

The calibration processing unit 15 performs registration of point cloud data for a predetermined period supplied from the information processing units 12-1 and 12-2, and similarly to the first embodiment, uses the point cloud data after the registration, the weight set by the weight setting unit 13, and the external parameters stored in the parameter storage unit 14 to calculate new external parameters that minimize the accumulated value of the cost for the predetermined period.

Here, the post-registration data of the point cloud data supplied from the information processing unit 12-1 is referred to as point cloud data Ca(i, t), and the post-registration data of the point cloud data supplied from the information processing unit 12-2 is referred to as point cloud data L(i, t). Note that “t” denotes a time index, and “i” denotes a feature point index. Furthermore, the external parameters are assumed as a translation parameter T and a rotation parameter R.

The calibration processing unit 15 calculates a cost E on the basis of Formula (2), using a weight Wdist(i) for a feature point of a feature point index i set by the weight setting unit 13. Additionally, the calibration processing unit 15 calculates a translation parameter T and a rotation parameter R that minimize the calculated cost E. The calibration processing unit 15 outputs the translation parameter T and the rotation parameter R that minimize the cost E, to the parameter update unit 16.

[Mathematical Formula 2]

E=Σ_{t∈m}(Σ_{i∈n}∥RCa_{(i,t)}+T−L_{(i,t)}∥²w_{dist(i)}) (2)

The parameter update unit 16 updates the external parameters in the parameter storage unit 14 at a predetermined timing, using the translation parameter T and the rotation parameter R supplied from the calibration processing unit 15, similarly to the first embodiment.

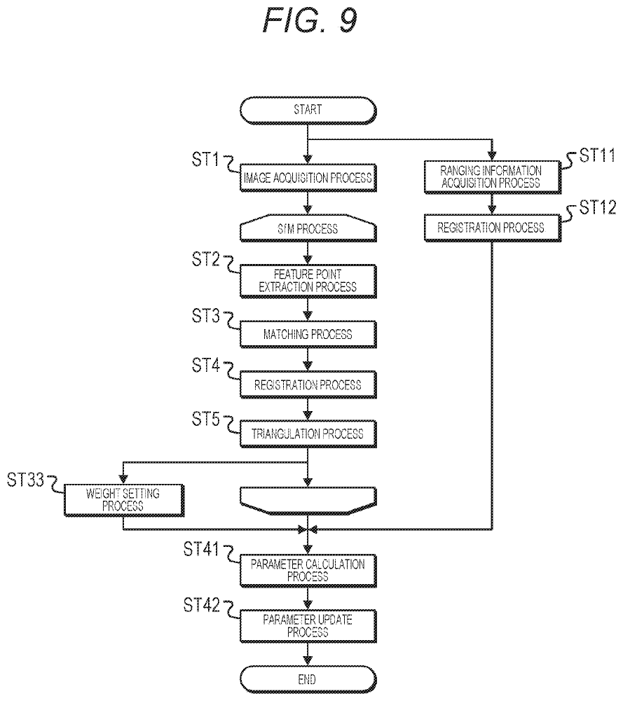

FIG. 9 is a flowchart exemplifying working of the second embodiment. Note that the processes in steps ST1 to ST12 are similar to the processes in the first embodiment.

In step ST1, a calibration apparatus performs an image acquisition process, and proceeds to step ST2. In step ST2, the calibration apparatus performs a feature point detection process in the SfM process, and proceeds to step ST3. In step ST3, the calibration apparatus performs a matching process, and proceeds to step ST4. In step ST4, the calibration apparatus performs a registration process, and proceeds to step ST5. In step ST5, the calibration apparatus performs a triangulation process to calculate a distance for each feature point, treats the calculated distance as point cloud data, and proceeds to step ST41.

In step ST11, the calibration process performs a ranging information acquisition process, and proceeds to step ST12. In step ST12, the calibration apparatus performs a registration process. The information processing unit 12-2 detects point cloud data of a corresponding point from the point cloud data for each time obtained in step ST11, and proceeds to step ST41.

In step ST33, the calibration apparatus performs a weight setting process. The weight setting unit 13 of the calibration apparatus sets a weight according to the distance calculated in step ST5, and proceeds to step ST41.

In step ST41, the calibration apparatus performs a parameter calculation process. The calibration processing unit 15 of the calibration apparatus determines a correspondence between the point cloud data obtained in the processes in steps ST1 to ST5 and the point cloud data obtained in the processes in steps ST11 and ST12, and as indicated by above Formula (2), calculates the cost using the corresponding pieces of point cloud data and the weight set in step ST33. Furthermore, the calibration processing unit 15 calculates a translation parameter T and a rotation parameter R that minimize the accumulated value of the cost for the predetermined period, and proceeds to step ST42.

In step ST42, the calibration apparatus performs a parameter update process. The parameter update unit 16 of the calibration apparatus updates the external parameters stored in the parameter storage unit 14 using the translation parameter T and the rotation parameter R calculated in step ST41.

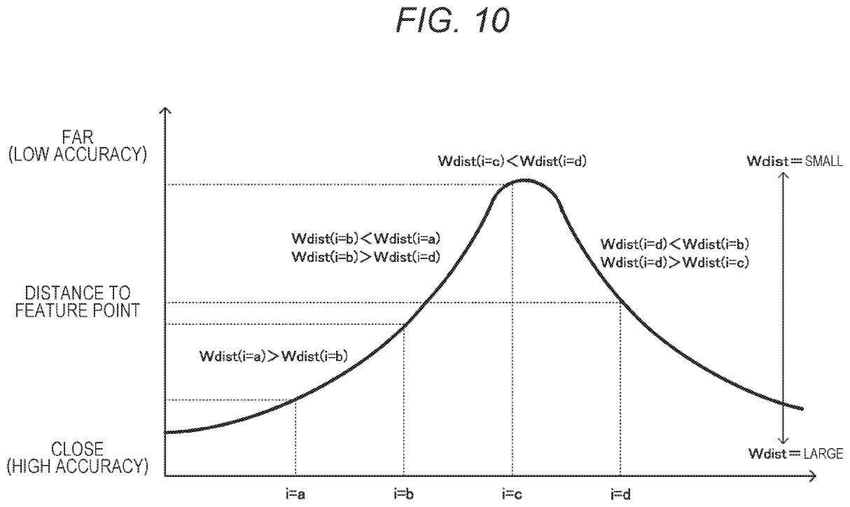

According to such a second embodiment, the weight for the cost is reduced for a feature point that is far apart in distance. FIG. 10 is a diagram illustrating a working example of the second embodiment. In a case where “a<b<c<d” is held for distances to feature points indicated by feature point indexes i=a, b, c, and d, a weight Wdist (i=a) for the feature point index i=a is designated as a value larger than the values of the other feature point indexes. Furthermore, a weight Wdist (i=b) for the feature point index i=b is designated as a value smaller than the weight Wdist (i=a) for the feature point index i=a and larger than a weight Wdist (i=d) for the feature point index i=d. A weight Wdist (i=c) for the feature point index i=c is designated as a value smaller than the values of the other feature point indexes. Moreover, the weight Wdist (i=d) for the feature point index i=d is designated as a value smaller than the weight Wdist (i=b) for the feature point index i=b and larger than the weight Wdist (i=c) for the feature point index i=c.

As described above, in the second embodiment, the weight is reduced as the distance increases. Therefore, the influence of the deterioration in the ranging accuracy is lowered, and the calibration is allowed to be performed with higher accuracy and stability than a case where the calibration is performed without using the weight according to the distance.

### 4. Third Embodiment

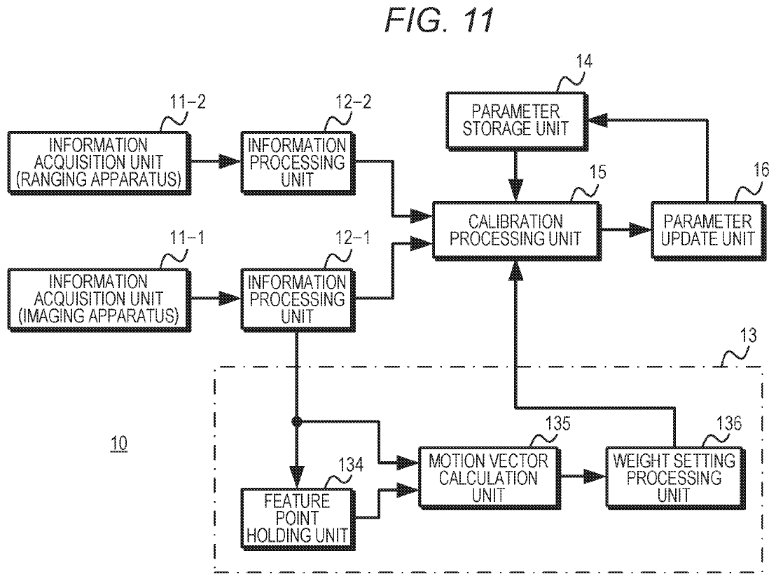

Next, a third embodiment will be described. FIG. 11 exemplifies a configuration of the third embodiment. In the third embodiment, two information acquisition units 11-1 and 11-2 are used. The information acquisition unit 11-1 is configured using an imaging apparatus so as to acquire a captured image. The information acquisition unit 11-2 is configured using a ranging apparatus, for example, a time-of-flight (TOF) camera, light detection and ranging or laser imaging detection and ranging (LIDAR), or the like, so as to acquire point cloud data indicating a ranging value. Furthermore, a weight setting unit 13 uses a motion vector for each feature point as a situation between the peripheral object and the information acquisition units.

The information acquisition unit 11-1 outputs the acquired captured image to an information processing unit 12-1, and the information acquisition unit 11-2 outputs the acquired point cloud data to an information processing unit 12-2.

The information processing unit 12-1 performs the structure from motion (SfM) process, and generates point cloud data for each feature point detected from a plurality of captured images in chronological order acquired by the information acquisition unit 11-1 to output the generated point cloud data to a calibration processing unit 15. Furthermore, the information processing unit 12-1 outputs the detected feature point to the weight setting unit 13.

The information processing unit 12-2 performs the registration process on a quantification result for a distance to each position of the peripheral object acquired by the information acquisition unit 11-1, and generates point cloud data for each position of the peripheral object as point cloud data for each feature point to output the generated point cloud data to the calibration processing unit 15.

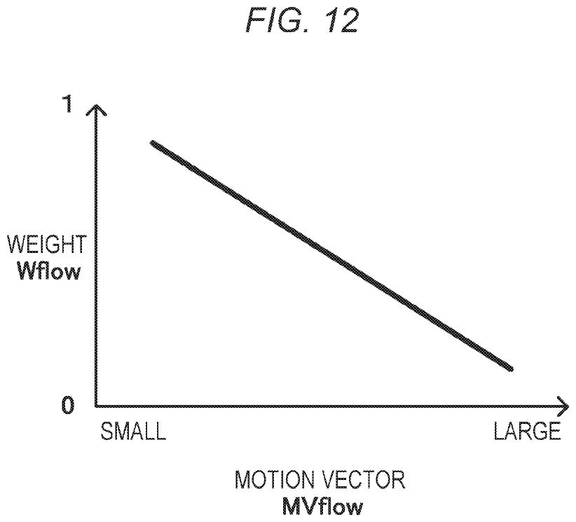

The weight setting unit 13 includes a feature point holding unit 134, a motion vector calculation unit 135, and a weight setting processing unit 136. The feature point holding unit 134 stores a feature point detected by the information processing unit 12-1. Furthermore, the stored feature point is output to the motion vector calculation unit 135. The motion vector calculation unit 135 calculates a motion vector for each feature point from the position on the image of a feature point stored in the feature point holding unit 134 and the position on the image of a feature point detected thereafter by the information processing unit 12-1 and corresponding to the stored feature point, and outputs the calculated motion vector to the weight setting processing unit 136. The weight setting processing unit 136 sets the weight according to the motion vector calculated by the motion vector calculation unit 135. Here, when the motion vector is larger, there is a possibility that the ranging accuracy is deteriorated as compared to a case where the motion vector is smaller; accordingly, the weight setting processing unit 136 reduces the weight as the motion vector increases. FIG. 12 exemplifies a relationship between a magnitude (norm) of the motion vector and a weight, and the weight setting processing unit 136 sets a weight Wflow according to a motion vector MVflow calculated by the motion vector calculation unit 135 to output the set weight Wflow to the calibration processing unit 15.

A parameter storage unit 14 stores, for example, external parameters between the information acquisition units 11-1 and 11-2, and the stored external parameters can be updated by a parameter update unit 16.

The calibration processing unit 15 performs registration of point cloud data for a predetermined period supplied from the information processing units 12-1 and 12-2, and uses the point cloud data after the registration, the weight set by the weight setting unit 13, and the external parameters stored in the parameter storage unit 14 to calculate new external parameters that minimize the cost.

Here, the post-registration data of the point cloud data supplied from the information processing unit 12-1 is referred to as point cloud data Ca(i, t), and the post-registration data of the point cloud data supplied from the information processing unit 12-2 is referred to as point cloud data L(i, t). Note that “t” denotes a time index, and “i” denotes a feature point index. Furthermore, the external parameters are assumed as a translation parameter T and a rotation parameter R.

The calibration processing unit 15 calculates a cost E on the basis of Formula (3), using a weight Wflow(i) for a feature point of a feature point index i set by the weight setting unit 13. Additionally, the calibration processing unit 15 calculates a translation parameter T and a rotation parameter R that minimize the calculated cost E. The calibration processing unit 15 outputs the translation parameter T and the rotation parameter R that minimize the cost E, to the parameter update unit 16.

[Mathematical Formula 3]

E=Σ_{t∈m}(Σ_{iΣn}∥RCa_{(i,t)}+T−L_{(i,t)}∥²w_{flow(i)}) (3)

The parameter update unit 16 updates the external parameters in the parameter storage unit 14 at a predetermined timing, using the translation parameter T and the rotation parameter R supplied from the calibration processing unit 15.

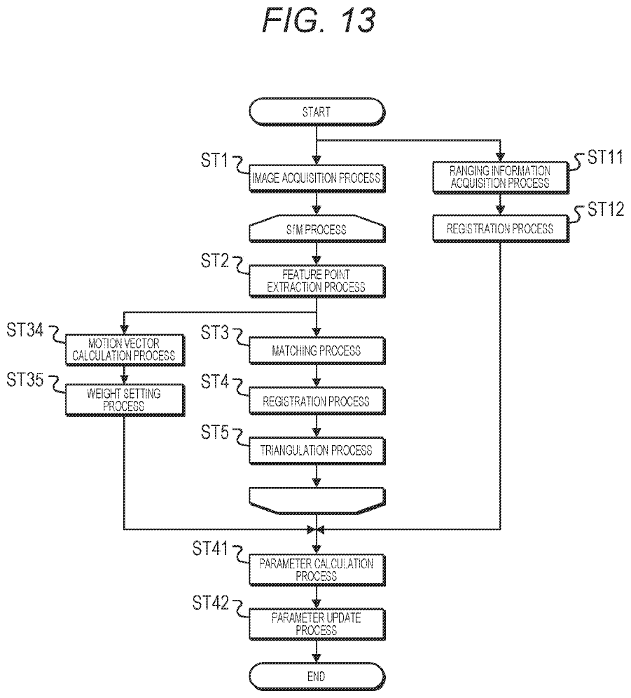

FIG. 13 is a flowchart exemplifying working of the third embodiment. Note that the processes in steps ST1 to ST12 are similar to the processes in the first embodiment.

In step ST1, a calibration apparatus performs an image acquisition process, and proceeds to step ST2. In step ST2, the calibration apparatus performs a feature point detection process in the SfM process, and proceeds to step ST3. In step ST3, the calibration apparatus performs a matching process, and proceeds to step ST4. In step ST4, the calibration apparatus performs a registration process, and proceeds to step ST5. In step ST5, the calibration apparatus performs a triangulation process to calculate a distance for each feature point, treats the calculated distance as point cloud data, and proceeds to step ST41.

In step ST11, the calibration process performs a ranging information acquisition process, and proceeds to step ST12. In step ST12, the calibration apparatus performs a registration process. The information processing unit 12-2 detects point cloud data of a corresponding point from the point cloud data for each time obtained in step ST11, and proceeds to step ST41.

In step ST34, the calibration apparatus performs a motion vector calculation process. The weight setting unit 13 of the calibration apparatus calculates a motion vector in the motion vector calculation unit 135 on the basis of the feature point detected in step ST2 and stored in the feature point holding unit 134 and a corresponding feature point detected from a captured image thereafter, and proceeds to step ST35.

In step ST35, the calibration apparatus performs a weight setting process. The weight setting unit 13 of the calibration apparatus sets the weight in the weight setting processing unit 136 according to the motion vector detected in step ST34, and proceeds to step ST41.

In step ST41, the calibration apparatus performs a parameter calculation process. The calibration processing unit 15 of the calibration apparatus determines a correspondence between the point cloud data obtained in the processes in steps ST1 to ST5 and the point cloud data obtained in the processes in steps ST11 and ST12, and as indicated by above Formula (3), calculates the cost using the corresponding pieces of point cloud data and the weight set in step ST35. Furthermore, the calibration processing unit 15 calculates a translation parameter T and a rotation parameter R that minimize the accumulated value of the cost for the predetermined period, and proceeds to step ST42.

In step ST42, the calibration apparatus performs a parameter update process. The parameter update unit 16 of the calibration apparatus updates the external parameters stored in the parameter storage unit 14 using the translation parameter T and the rotation parameter R calculated in step ST41.

According to such a third embodiment, the weight is reduced for a feature point having a larger motion vector, such that the influence of motion is lowered, and the calibration is allowed to be performed with higher accuracy and stability than a case where the calibration is performed without using the weight according to the motion vector.

### 5. Fourth Embodiment

Next, a fourth embodiment will be described. In the above-described first embodiment, the calibration using the weight according to the speed is performed using the imaging apparatus and the ranging apparatus; however, in the fourth embodiment, the calibration using the weight according to the speed is performed using a plurality of imaging apparatuses.

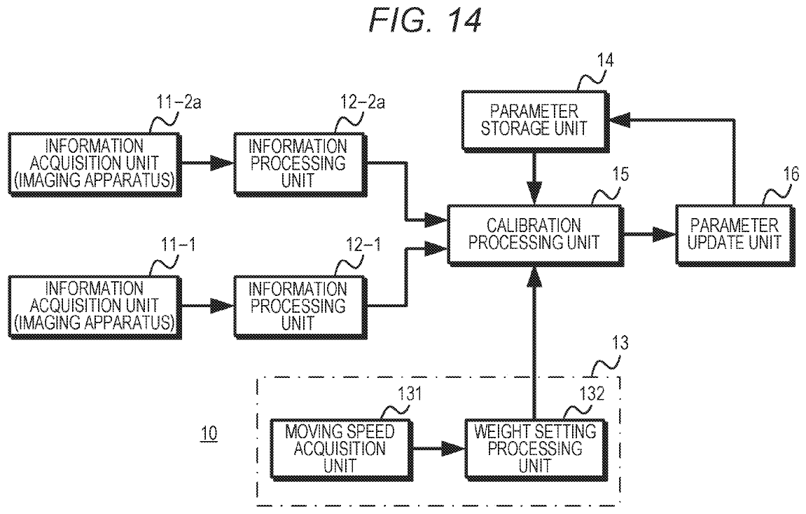

FIG. 14 exemplifies a configuration of the fourth embodiment, and in the fourth embodiment, two information acquisition units 11-1 and 11-2a are used. The information acquisition units 11-1 and 11-2a are configured using imaging apparatuses so as to acquire captured images. A weight setting unit 13 sets the weight according to the moving speed, similarly to the first embodiment.

The information acquisition unit 11-1 outputs the acquired captured image to an information processing unit 12-1, and the information acquisition unit 11-2a outputs the acquired captured image to an information processing unit 12-2a.

The information processing units 12-1 and 12-2a each perform the structure from motion (SfM) process, and detect a feature point from a plurality of captured images in chronological order for each captured image, to generate point cloud data indicating feature points corresponding in a time direction for each feature point, from the detected feature points, and output the generated point cloud data to a calibration processing unit 15.

The weight setting unit 13 includes a moving speed acquisition unit 131 and a weight setting processing unit 132. The moving speed acquisition unit 131 is configured using a sensor or the like capable of detecting the moving speed of a moving body. For example, in a case where the moving body is a vehicle, the moving speed acquisition unit 131 is configured using a vehicle speed detection sensor, and outputs speed information indicating the detected moving speed to the weight setting processing unit 132.

The weight setting processing unit 132 sets the weight according to the moving speed acquired by the moving speed acquisition unit 131. Here, in a case where the information acquisition units 11-1 and 11-2a acquire the captured images asynchronously, there is a case where the position of the peripheral object has a larger difference between the captured images when the moving speed increases. Thus, the weight setting processing unit 132 reduces the weight as the moving speed increases. Similarly to the first embodiment, the weight setting processing unit 132 sets a weight Wsp according to a moving speed Vsp that has been acquired, on the basis of, for example, the relationship between the speed and the weight illustrated in FIG. 3, and outputs the set weight Wsp to the calibration processing unit 15.

A parameter storage unit 14 stores external parameters between the information acquisition units 11-1 and 11-2a, and the stored external parameters can be updated by a parameter update unit 16.

The calibration processing unit 15 performs registration of point cloud data for a predetermined period supplied from the information processing units 12-1 and 12-2a, and uses the point cloud data after the registration, the weight set by the weight setting unit 13, and the external parameters stored in the parameter storage unit 14 to calculate new external parameters that minimize the cost.

Here, the post-registration data of the point cloud data supplied from the information processing unit 12-1 is referred to as point cloud data Ca(i, t), and the post-registration data of the point cloud data supplied from the information processing unit 12-2a is referred to as point cloud data L(i, t). Note that “t” denotes a time index, and “i” denotes a feature point index. Furthermore, the external parameters are assumed as a translation parameter T and a rotation parameter R.

The calibration processing unit 15 calculates a cost E on the basis of Formula (4), using a weight Wsp(t) for each time index set by the weight setting unit 13. Additionally, in a case where the calculated cost E is not the minimum, the calibration processing unit 15 newly calculates a translation parameter T and a rotation parameter R that minimize the cost E. The calibration processing unit 15 outputs the translation parameter T and the rotation parameter R that minimize the cost E, to the parameter update unit 16.

[Mathematical Formula 4]

E=Σ_{t∈m}(wₛₚ₍ₜ₎Σ_{i∈n}∥RCa_{(i,t)}+T−Cb_{(i,t)}∥²) (4)

The parameter update unit 16 updates the external parameters in the parameter storage unit 14 at a predetermined timing, using the translation parameter T and the rotation parameter R supplied from the calibration processing unit 15.

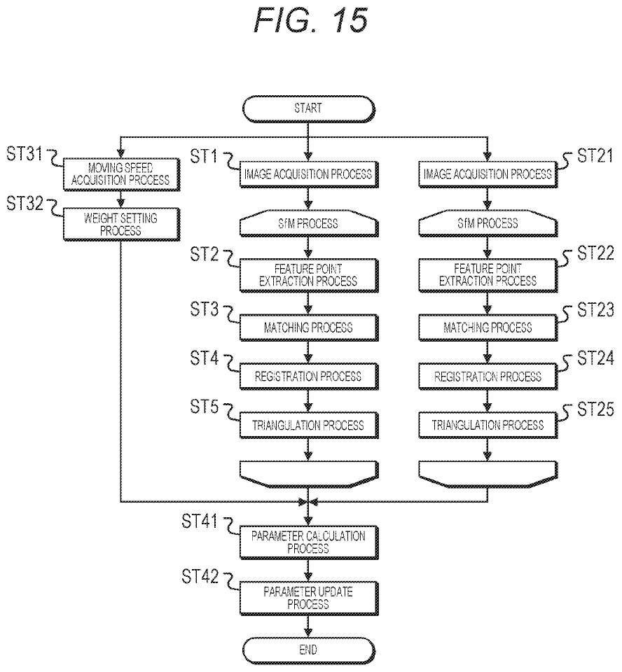

FIG. 15 is a flowchart exemplifying working of the fourth embodiment. In step ST1, a calibration apparatus performs an image acquisition process to acquire a captured image from the information acquisition unit 11-1, and proceeds to step ST2. In step ST2, the calibration apparatus performs a feature point detection process in the SfM process, and proceeds to step ST3. In step ST3, the calibration apparatus performs a matching process, and proceeds to step ST4. In step ST4, the calibration apparatus performs a registration process, and proceeds to step ST5. In step ST5, the calibration apparatus performs a triangulation process to calculate a distance for each feature point, treats the calculated distance as point cloud data, and proceeds to step ST41.

In step ST21, the calibration apparatus performs an image acquisition process to acquire a captured image from the information acquisition unit 11-2a, and proceeds to step ST22. In step ST22, the calibration apparatus performs a feature point detection process in the SfM process, and proceeds to step ST23. In step ST23, the calibration apparatus performs a matching process, and proceeds to step ST24. In step ST24, the calibration apparatus performs a registration process, and proceeds to step ST25. In step ST25, the calibration apparatus performs a triangulation process to calculate a distance for each feature point, treats the calculated distance as point cloud data, and proceeds to step ST41.

In step ST31, the calibration apparatus performs a moving speed acquisition process. The weight setting unit 13 of the calibration apparatus includes the moving speed acquisition unit 131 and the weight setting processing unit 132. The moving speed acquisition unit 131 acquires, for example, from a vehicle speed detection sensor, speed information indicating the moving speed of a moving body provided with the information acquisition units 11-1 and 11-2a, and proceeds to step ST32.

In step ST32, the calibration apparatus performs a weight setting process. The weight setting unit 13 of the calibration apparatus sets a weight on the basis of the speed information acquired in step ST31, and proceeds to step ST41.

In step ST41, the calibration apparatus performs a parameter calculation process. The calibration processing unit 15 of the calibration apparatus determines a correspondence between the point cloud data obtained in the processes in steps ST1 to ST4 and the point cloud data obtained in the processes in steps ST21 to ST25, and as indicated by above Formula (4), calculates the cost using the corresponding pieces of point cloud data and the weight set in step ST32. Furthermore, the calibration processing unit 15 calculates a translation parameter T and a rotation parameter R that minimize the accumulated value of the cost for the predetermined period, and proceeds to step ST42.

In step ST42, the calibration apparatus performs a parameter update process. The parameter update unit 16 of the calibration apparatus updates the external parameters stored in the parameter storage unit 14 using the translation parameter T and the rotation parameter R calculated in step ST41.

According to such a fourth embodiment, the weight for the cost is reduced for a section where the moving speed is higher, also in a case where a plurality of imaging apparatuses is used. Therefore, similarly to the first embodiment, the calibration is allowed to be performed with higher accuracy and stability than a case where the calibration is performed without using the weight according to the speed.

### 6. Fifth Embodiment

Next, a fifth embodiment will be described. In the above-described second embodiment, the calibration using the weight according to the distance to the peripheral object is performed using the imaging apparatus and the ranging apparatus; however, in the fifth embodiment, the calibration using the weight according to the distance to the peripheral object is performed using a plurality of imaging apparatuses.

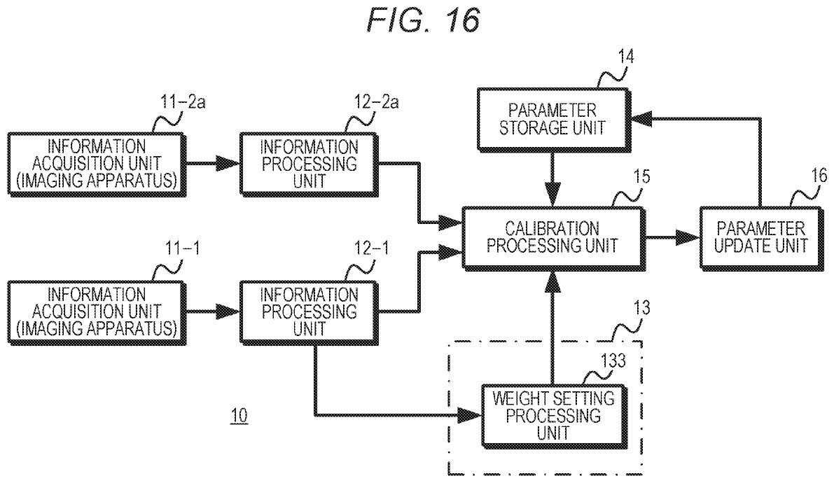

FIG. 16 exemplifies a configuration of the fifth embodiment, and in the fifth embodiment, two information acquisition units 11-1 and 11-2a are used. The information acquisition units 11-1 and 11-2a are configured using imaging apparatuses so as to acquire captured images. A weight setting unit 13 sets the weight according to the distance, similarly to the second embodiment.

The information acquisition unit 11-1 outputs the acquired captured image to an information processing unit 12-1, and the information acquisition unit 11-2a outputs the acquired captured image to an information processing unit 12-2a.

The information processing units 12-1 and 12-2a each perform the structure from motion (SfM) process, and detect a feature point from a plurality of captured images in chronological order for each captured image, to generate point cloud data indicating feature points corresponding in a time direction for each feature point, from the detected feature points, and output the generated point cloud data to a calibration processing unit 15.

The weight setting unit 13 includes a weight setting processing unit 133. The weight setting processing unit 133 sets a weight according to the distance for each feature point acquired from the information processing unit 12-1. Here, since there is a possibility that the ranging accuracy is deteriorated when the distance increases, the weight setting processing unit 133 reduces the weight as the distance increases. Similarly to the second embodiment, the weight setting processing unit 133 sets a weight Wdist according to a distance Ldist that has been acquired, on the basis of, for example, the relationship between the distance and the weight illustrated in FIG. 8, and outputs the set weight Wdist to the calibration processing unit 15.

A parameter storage unit 14 stores external parameters between the information acquisition units 11-1 and 11-2a, and the stored external parameters can be updated by a parameter update unit 16.

The calibration processing unit 15 performs registration of point cloud data for a predetermined period supplied from the information processing units 12-1 and 12-2a, and uses the point cloud data after the registration, the weight set by the weight setting unit 13, and the external parameters stored in the parameter storage unit 14 to calculate new external parameters that minimize the cost for the predetermined period.

Here, the post-registration data of the point cloud data supplied from the information processing unit 12-1 is referred to as point cloud data Ca(i, t), and the post-registration data of the point cloud data supplied from the information processing unit 12-2a is referred to as point cloud data L(i, t). Note that “t” denotes a time index, and “i” denotes a feature point index. Furthermore, the external parameters are assumed as a translation parameter T and a rotation parameter R.

The calibration processing unit 15 calculates a cost E on the basis of Formula (5), using a weight Wdist(i) for a feature point of a feature point index i set by the weight setting unit 13. Additionally, the calibration processing unit 15 calculates a translation parameter T and a rotation parameter R that minimize the calculated cost E. The calibration processing unit 15 outputs the translation parameter T and the rotation parameter R that minimize the cost E, to the parameter update unit 16.

[Mathematical Formula 5]

E=Σ_{t∈m}(Σ_{i∈n}∥RCa_{(i,t)}+T−Cb_{(i,t)}∥²w_{dist(i)}) (5)

The parameter update unit 16 updates the external parameters in the parameter storage unit 14 at a predetermined timing, using the translation parameter T and the rotation parameter R supplied from the calibration processing unit 15.

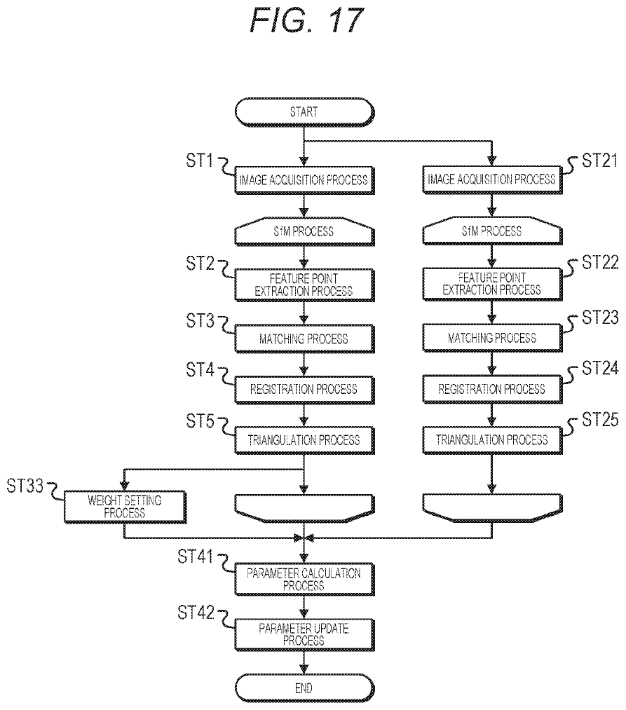

FIG. 17 is a flowchart exemplifying working of the fifth embodiment. In step ST1, a calibration apparatus performs an image acquisition process to acquire a captured image from the information acquisition unit 11-1, and proceeds to step ST2. In step ST2, the calibration apparatus performs a feature point detection process in the SfM process, and proceeds to step ST3. In step ST3, the calibration apparatus performs a matching process, and proceeds to step ST4. In step ST4, the calibration apparatus performs a registration process, and proceeds to step ST5. In step ST5, the calibration apparatus performs a triangulation process to calculate a distance for each feature point, treats the calculated distance as point cloud data, and proceeds to step ST41.

In step ST21, the calibration apparatus performs an image acquisition process to acquire a captured image from the information acquisition unit 11-2a, and proceeds to step ST22. In step ST22, the calibration apparatus performs a feature point detection process in the SfM process, and proceeds to step ST23. In step ST23, the calibration apparatus performs a matching process, and proceeds to step ST24. In step ST24, the calibration apparatus performs a registration process, and proceeds to step ST25. In step ST25, the calibration apparatus performs a triangulation process to calculate a distance for each feature point, treats the calculated distance as point cloud data, and proceeds to step ST41.

In step ST33, the calibration apparatus performs a weight setting process. The weight setting unit 13 of the calibration apparatus sets a weight according to the distance calculated in step ST5, and proceeds to step ST41.

In step ST41, the calibration apparatus performs a parameter calculation process. The calibration processing unit 15 of the calibration apparatus determines a correspondence between the point cloud data obtained in the processes in steps ST1 to ST5 and the point cloud data obtained in the processes in steps ST21 to ST25, and as indicated by above Formula (5), calculates the cost using the corresponding pieces of point cloud data and the weight set in step ST33. Furthermore, the calibration processing unit 15 calculates the external parameters, that is, the translation parameter T and the rotation parameter R that minimize the accumulated value of the cost for the predetermined period, and proceeds to step ST42.

In step ST42, the calibration apparatus performs a parameter update process. The parameter update unit 16 of the calibration apparatus updates the external parameters stored in the parameter storage unit 14 using the translation parameter T and the rotation parameter R calculated in step ST41.

According to such a fifth embodiment, the weight for the cost is reduced for a feature point that is far apart in distance, also in a case where a plurality of imaging apparatuses is used. Therefore, similarly to the second embodiment, the calibration is allowed to be performed with higher accuracy and stability than a case where the calibration is performed without using the weight according to the distance.

### 7. Sixth Embodiment

Next, a sixth embodiment will be described. In the above-described third embodiment, the calibration using the weight according to the motion vector is performed using the imaging apparatus and the ranging apparatus; however, in the sixth embodiment, the calibration using the weight according to the motion vector is performed using a plurality of imaging apparatuses.

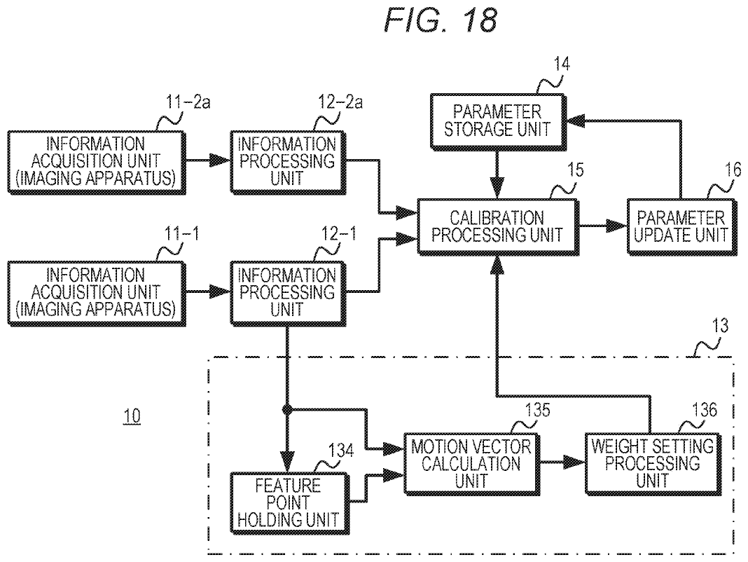

FIG. 18 exemplifies a configuration of the sixth embodiment, and in the sixth embodiment, two information acquisition units 11-1 and 11-2a are used. The information acquisition units 11-1 and 11-2a are configured using imaging apparatuses so as to acquire captured images. A weight setting unit 13 sets the weight according to the motion vector, similarly to the third embodiment.

The information acquisition unit 11-1 outputs the acquired captured image to an information processing unit 12-1, and the information acquisition unit 11-2a outputs the acquired captured image to an information processing unit 12-2a.

The information processing units 12-1 and 12-2a each perform the structure from motion (SfM) process, and detect a feature point from a plurality of captured images in chronological order for each captured image, to generate point cloud data indicating feature points corresponding in a time direction for each feature point, from the detected feature points, and output the generated point cloud data to a calibration processing unit 15.

The weight setting unit 13 includes a feature point holding unit 134, a motion vector calculation unit 135, and a weight setting processing unit 136. The feature point holding unit 134 stores a feature point detected by the information processing unit 12-1. Furthermore, the stored feature point is output to the motion vector calculation unit 135. The motion vector calculation unit 135 calculates a motion vector for each feature point from the position on the image of a feature point stored in the feature point holding unit 134 and the position on the image of a feature point detected thereafter by the information processing unit 12-1 and corresponding to the stored feature point, and outputs the calculated motion vector to the weight setting processing unit 136. The weight setting processing unit 136 sets the weight according to the motion vector calculated by the motion vector calculation unit 135. Here, when the motion vector is larger, there is a possibility that the ranging accuracy is deteriorated as compared to a case where the motion vector is smaller; thus, the weight setting processing unit 136 reduces the weight as the motion vector increases. Similarly to the third embodiment, the weight setting processing unit 136 sets a weight Wflow according to a motion vector MVflow calculated by the motion vector calculation unit 135, on the basis of the relationship between the magnitude of the motion vector and the weight illustrated in FIG. 12, and outputs the set weight Wflow to the calibration processing unit 15.

A parameter storage unit 14 stores external parameters between the information acquisition units 11-1 and 11-2a, and the stored external parameters can be updated by a parameter update unit 16.

The calibration processing unit 15 performs registration of point cloud data for a predetermined period supplied from the information processing units 12-1 and 12-2a, and uses the point cloud data after the registration, the weight set by the weight setting unit 13, and the external parameters stored in the parameter storage unit 14 to calculate new external parameters that minimize the cost.

Here, the post-registration data of the point cloud data supplied from the information processing unit 12-1 is referred to as point cloud data Ca(i, t), and the post-registration data of the point cloud data supplied from the information processing unit 12-2a is referred to as point cloud data L(i, t). Note that “t” denotes a time index, and “i” denotes a feature point index. Furthermore, the external parameters are assumed as a translation parameter T and a rotation parameter R.

The calibration processing unit 15 calculates a cost E on the basis of Formula (6), using a weight Wflow(i) for a feature point of a feature point index i set by the weight setting unit 13. Additionally, the calibration processing unit 15 calculates a translation parameter T and a rotation parameter R that minimize the calculated cost E. The calibration processing unit 15 outputs the translation parameter T and the rotation parameter R that minimize the cost E, to the parameter update unit 16.

[Mathematical Formula 6]

E=Σ_{t∈m}(Σ_{i∈n}∥RCa_{(i,t)}+T−Cb_{(i,t)}∥²w_{flow(i)}) (6)

The parameter update unit 16 updates the external parameters in the parameter storage unit 14 at a predetermined timing, using the translation parameter T and the rotation parameter R supplied from the calibration processing unit 15.

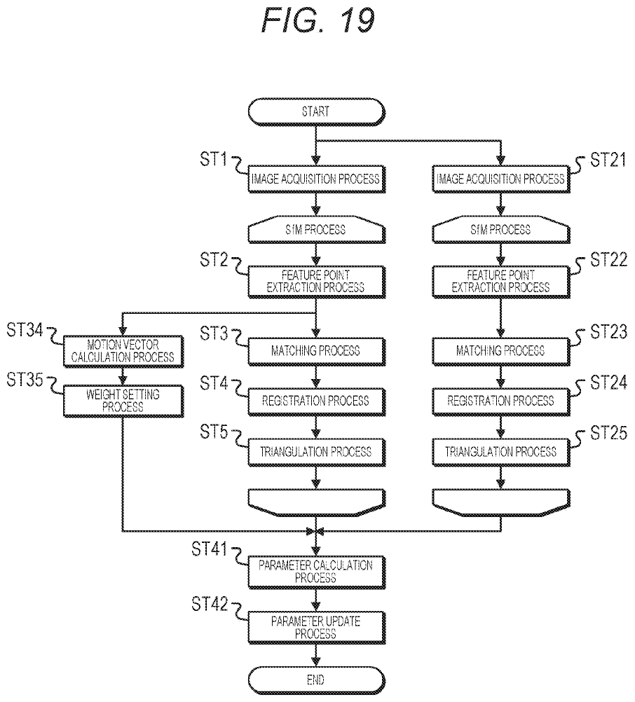

FIG. 19 is a flowchart exemplifying working of the sixth embodiment. In step ST1, a calibration apparatus performs an image acquisition process, and proceeds to step ST2. In step ST2, the calibration apparatus performs a feature point detection process in the SfM process, and proceeds to step ST3. In step ST3, the calibration apparatus performs a matching process, and proceeds to step ST4. In step ST4, the calibration apparatus performs a registration process, and proceeds to step ST5. In step ST5, the calibration apparatus performs a triangulation process to calculate a distance for each feature point, treats the calculated distance as point cloud data, and proceeds to step ST41.

In step ST21, the calibration apparatus performs an image acquisition process to acquire a captured image from the information acquisition unit 11-2a, and proceeds to step ST22. In step ST22, the calibration apparatus performs a feature point detection process in the SfM process, and proceeds to step ST23. In step ST23, the calibration apparatus performs a matching process, and proceeds to step ST24. In step ST24, the calibration apparatus performs a registration process, and proceeds to step ST25. In step ST25, the calibration apparatus performs a triangulation process to calculate a distance for each feature point, treats the calculated distance as point cloud data, and proceeds to step ST41.

In step ST34, the calibration apparatus performs a motion detection process. The weight setting unit 13 of the calibration apparatus calculates a motion vector in the motion vector calculation unit 135 on the basis of the feature point detected in step ST2 and stored in the feature point holding unit 134 and a corresponding feature point detected from a captured image thereafter, and proceeds to step ST35.

In step ST35, the calibration apparatus performs a weight setting process. The weight setting unit 13 of the calibration apparatus sets the weight in the weight setting processing unit 136 according to the motion vector detected in step ST34, and proceeds to step ST41.

In step ST41, the calibration apparatus performs a parameter calculation process. The calibration processing unit 15 of the calibration apparatus determines a correspondence between the point cloud data obtained in the processes in steps ST1 to ST5 and the point cloud data obtained in the processes in steps ST21 to ST25, and as indicated by above Formula (6), calculates the cost using the corresponding pieces of point cloud data and the weight set in step ST35. Furthermore, the calibration processing unit 15 calculates a translation parameter T and a rotation parameter R that minimize the accumulated value of the cost for the predetermined period, and proceeds to step ST42.

In step ST42, the calibration apparatus performs a parameter update process. The parameter update unit 16 of the calibration apparatus updates the external parameters stored in the parameter storage unit 14 using the translation parameter T and the rotation parameter R calculated in step ST41.

According to such a sixth embodiment, the weight for the cost is reduced for a feature point having a larger motion vector, also in a case where a plurality of imaging apparatuses is used. Therefore, similarly to the third embodiment, the calibration is allowed to be performed with higher accuracy and stability than a case where the calibration is performed without using the weight according to the motion vector.

### 8. Other Embodiments

Incidentally, the above-described embodiments exemplify cases in which the cost is calculated by individually using the weight according to the speed, the weight according to the distance, and the weight according to the movement vector. However, the weights are not restricted to being used individually, and a plurality of weights may be used in combination. The cost may be calculated using the weight according to the speed and the weight according to the distance such that the external parameters that minimize the cost are calculated.

### 9. Application Examples

The technology according to the present disclosure can be applied to a variety of products. For example, the technology according to the present disclosure may be implemented as an apparatus to be equipped in any type of moving body such as automobile, electric automobile, hybrid electric automobile, motorcycle, bicycle, personal mobility, airplane, drone, ship, robot, construction machine, and agricultural machine (tractor).

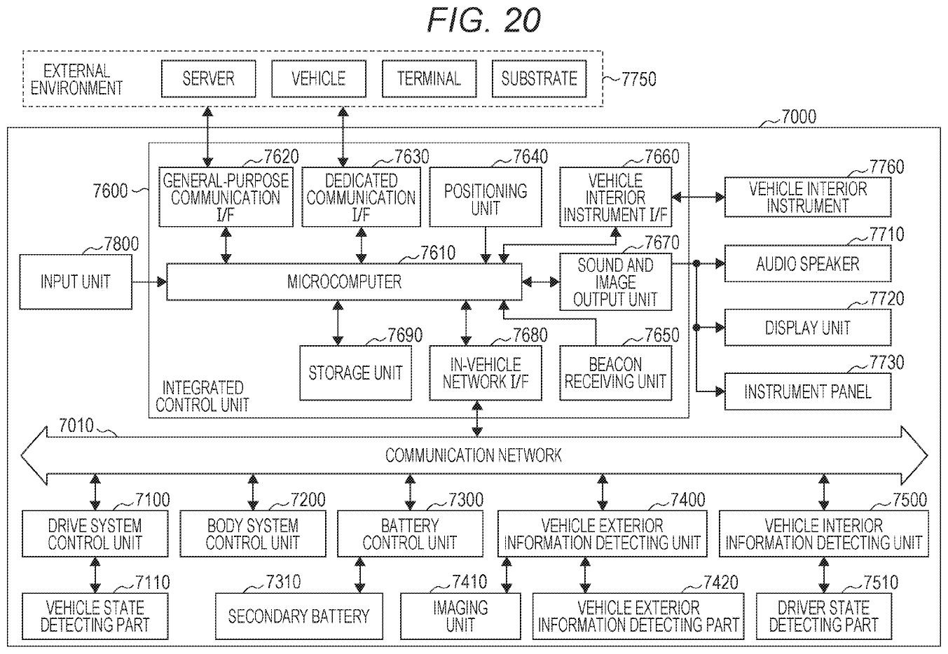

FIG. 20 is a block diagram illustrating a schematic configuration example of a vehicle control system 7000, which is an example of a moving body control system to which the technology according to the present disclosure can be applied. The vehicle control system 7000 includes a plurality of electronic control units connected via a communication network 7010. In the example illustrated in FIG. 20, the vehicle control system 7000 includes a drive system control unit 7100, a body system control unit 7200, a battery control unit 7300, a vehicle exterior information detecting unit 7400, a vehicle interior information detecting unit 7500, and an integrated control unit 7600. The communication network 7010 connecting this plurality of control units can be an in-vehicle communication network conforming to an arbitrary standard such as a controller area network (CAN), a local interconnect network (LIN), a local area network (LAN), and FlexRay (registered trademark), for example.

Each control unit includes a microcomputer that performs computational processes in accordance with various programs, a storage unit that stores programs executed by the microcomputer or parameters used for various computational tasks, and the like, and a drive circuit that drives various apparatuses to be controlled. Each control unit includes a network interface (I/F) for communicating with another control unit via the communication network 7010 and also includes a communication I/F for performing communication with an apparatus or a sensor or the like inside and outside the vehicle by wired communication or wireless communication. In FIG. 20, a microcomputer 7610, a general-purpose communication I/F 7620, a dedicated communication I/F 7630, a positioning unit 7640, a beacon receiving unit 7650, a vehicle interior instrument I/F 7660, a sound and image output unit 7670, an in-vehicle network I/F 7680, and a storage unit 7690 are illustrated as a functional configuration of the integrated control unit 7600. Similarly, the other control units each include a microcomputer, a communication I/F, a storage unit, and the like.

The drive system control unit 7100 controls working of an apparatus related to a drive system of the vehicle in accordance with various programs. For example, the drive system control unit 7100 functions as control apparatuses such as a driving force generating apparatus for generating a driving force of the vehicle, such as an internal combustion engine or a driving motor, a driving force transmitting mechanism for transmitting a driving force to wheels, a steering mechanism that regulates a steer angle of the vehicle, and a braking apparatus that generates a braking force of the vehicle. The drive system control unit 7100 may have a function as a control apparatus such as an antilock brake system (ABS) or an electronic stability control (ESC).

A vehicle state detecting part 7110 is connected to the drive system control unit 7100. For example, the vehicle state detecting part 7110 includes a gyro sensor that detects an angular velocity of the axial rotational movement of a vehicle body, an acceleration sensor that detects the acceleration of the vehicle, or at least one of sensors for detecting an operation amount of an accelerator pedal, an operation amount of a brake pedal, a steering angle of a steering wheel, engine speed, a rotation speed of the wheel, or the like. The drive system control unit 7100 performs computational processes using a signal input from the vehicle state detecting part 7110 and controls the internal combustion engine, the driving motor, an electric power steering apparatus, a brake apparatus, or the like.

The body system control unit 7200 controls working of various apparatuses attached in the vehicle body in accordance with various programs. For example, the body system control unit 7200 functions as a keyless entry system, a smart key system, a power window apparatus, or a control apparatus for various lamps such as a headlamp, a back lamp, a brake lamp, a turn signal lamp, or a fog lamp. In this case, the body system control unit 7200 can accept input of a radio wave distributed from a portable device that substitutes a key or signals from various switches. The body system control unit 7200 accepts input of the above-mentioned radio wave or signals and controls a door lock apparatus, the power window apparatus, the lamp, and the like of the vehicle.

The battery control unit 7300 controls a secondary battery 7310, which is a power supply source of the driving motor, in accordance with various programs. For example, information such as a battery temperature, a battery output voltage, a remaining capacity of the battery, or the like is input to the battery control unit 7300 from a battery apparatus including the secondary battery 7310. The battery control unit 7300 performs computational processes using these signals and controls temperature regulation for the secondary battery 7310 or a cooling apparatus or the like included in the battery apparatus.

The vehicle exterior information detecting unit 7400 detects information outside the vehicle equipped with the vehicle control system 7000. For example, at least one of an imaging unit 7410 or a vehicle exterior information detecting part 7420 is connected to the vehicle exterior information detecting unit 7400. The imaging unit 7410 includes at least one of a time-of-flight (ToF) camera, a stereo camera, a monocular camera, an infrared camera, or other cameras. The vehicle exterior information detecting part 7420 includes at least one of, for example, an environmental sensor for detecting the current weather or meteorology, or an ambient information detecting sensor for detecting another vehicle, an obstacle, a pedestrian, and the like around the vehicle equipped with the vehicle control system 7000.

The environmental sensor can be, for example, at least one of a raindrop sensor for detecting rain, a fog sensor for detecting fog, a sunshine sensor for detecting sunshine degree, or a snow sensor for detecting snowfall. The ambient information detecting sensor can be at least one of an ultrasonic sensor, a radar apparatus, or a light detection and ranging or laser imaging detection and ranging (LIDAR) apparatus. The imaging unit 7410 and the vehicle exterior information detecting part 7420 described above may be each provided as an independent sensor or apparatus, or may be provided as an apparatus in which a plurality of sensors or apparatuses is integrated.

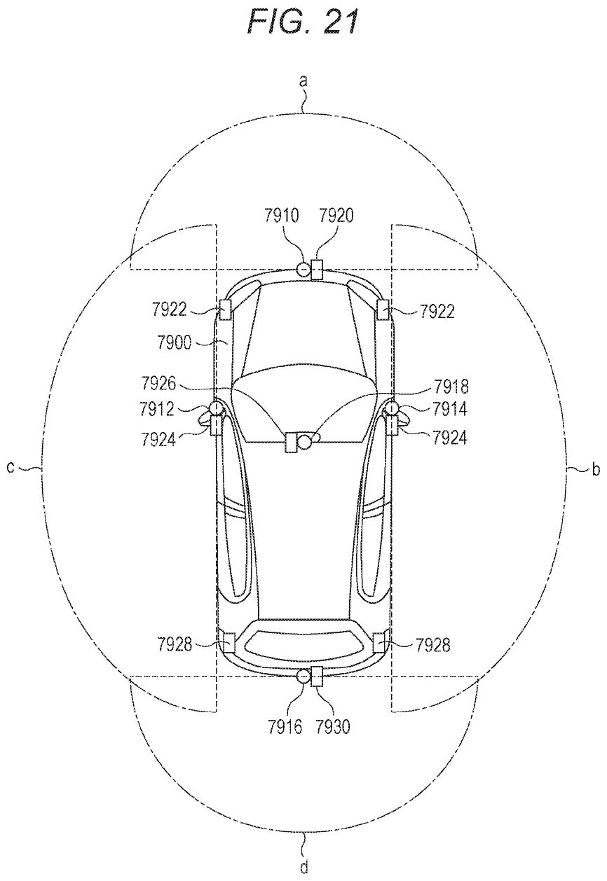

Here, FIG. 21 illustrates an example of installation positions of the imaging units 7410 and the vehicle exterior information detecting parts 7420. For example, imaging units 7910, 7912, 7914, 7916, and 7918 are provided at at least one position of a front nose, a side mirror, a rear bumper, a back door, or an upper portion of a windshield in a passenger compartment of a vehicle 7900. The imaging unit 7910 provided at the front nose and the imaging unit 7918 provided at the upper portion of the windshield in the passenger compartment mainly acquire an image ahead of the vehicle 7900. The imaging units 7912 and 7914 provided at the side mirrors mainly acquire images of the sides of the vehicle 7900. The imaging unit 7916 provided at the rear bumper or the back door mainly acquires an image behind the vehicle 7900. The imaging unit 7918 provided at the upper portion of the windshield in the passenger compartment is mainly used for detecting a preceding vehicle, a pedestrian, an obstacle, a traffic signal, a traffic sign, a lane, and the like.

Note that FIG. 21 illustrates an example of capturing ranges of the respective imaging units 7910, 7912, 7914, and 7916. An imaging range a indicates an imaging range of the imaging unit 7910 provided at the front nose, imaging ranges b and c indicate imaging ranges of the imaging units 7912 and 7914 provided at the side mirrors, respectively, and an imaging range d indicates an imaging range of the imaging unit 7916 provided at the rear bumper or the back door. For example, by overlapping image data captured by the imaging units 7910, 7912, 7914, and 7916, an overhead view image of the vehicle 7900 viewed from above is obtained.

Vehicle exterior information detecting parts 7920, 7922, 7924, 7926, 7928, and 7930 provided at the front, rear, sides, corners, and the upper portion of the windshield in the passenger compartment of the vehicle 7900 can be, for example, ultrasonic sensors or radar apparatuses. The vehicle exterior information detecting parts 7920, 7926, and 7930 provided at the front nose, the rear bumper or the back door, and the upper portion of the windshield in the passenger compartment of the vehicle 7900 can be, for example, LIDAR apparatuses. These vehicle exterior information detecting parts 7920 to 7930 are mainly used for detecting a preceding vehicle, a pedestrian, an obstacle, and the like.

Returning to FIG. 20, the explanation will be continued. The vehicle exterior information detecting unit 7400 causes the imaging unit 7410 to capture an image of the outside of the vehicle and receives the captured image data. Furthermore, the vehicle exterior information detecting unit 7400 receives detection information from the connected vehicle exterior information detecting part 7420. In a case where the vehicle exterior information detecting part 7420 is an ultrasonic sensor, radar apparatus, or a LIDAR apparatus, the vehicle exterior information detecting unit 7400 causes the vehicle exterior information detecting part 7420 to distribute ultrasonic waves, electromagnetic waves, or the like, and receives information on reflected waves that have been received. The vehicle exterior information detecting unit 7400 may perform an object detection process or a distance detection process for a person, a car, an obstacle, a sign, a character on a road surface, or the like on the basis of the received information. The vehicle exterior information detecting unit 7400 may perform an environment recognition process for recognizing rainfall, fog, road surface condition, or the like on the basis of the received information. The vehicle exterior information detecting unit 7400 may calculate a distance to an object outside the vehicle on the basis of the received information.

Furthermore, the vehicle exterior information detecting unit 7400 may perform an image recognition process or a distance detection process for recognizing a person, a car, an obstacle, a sign, a character on a road surface, or the like on the basis of the received image data. The vehicle exterior information detecting unit 7400 may perform processes such as distortion correction or alignment on the received image data and also merge the image data captured by different imaging units 7410 to generate an overhead view image or a panoramic image. The vehicle exterior information detecting unit 7400 may perform a viewpoint conversion process using image data captured by different imaging units 7410.

The vehicle interior information detecting unit 7500 detects information inside the vehicle. For example, a driver state detecting part 7510 that detects the state of the driver is connected to the vehicle interior information detecting unit 7500. The driver state detecting part 7510 may include a camera that images the driver, a biometric sensor that detects biometric information on the driver, a microphone that collects sound in the passenger compartment, and the like. The biometric sensor is provided, for example, on a seating surface or a steering wheel or the like and detects biometric information on an occupant sitting on a seat or the driver gripping the steering wheel. The vehicle interior information detecting unit 7500 may calculate the degree of fatigue or the degree of concentration of the driver or may determine whether or not the driver is dozing off, on the basis of detection information input from the driver state detecting part 7510. The vehicle interior information detecting unit 7500 may perform a process such as a noise canceling process on the collected sound signal.

The integrated control unit 7600 controls the whole working of the vehicle control system 7000 in accordance with various programs. An input unit 7800 is connected to the integrated control unit 7600. The input unit 7800 is implemented by an apparatus that can be operated by an occupant to make input, such as a touch panel, a button, a microphone, a switch, or a lever, for example. The integrated control unit 7600 may accept input of data obtained by performing sound recognition on sound input by the microphone. The input unit 7800 may be, for example, a remote control apparatus that utilizes infrared rays or other radio waves, or an external connection instrument compatible with the operation of the vehicle control system 7000, such as a mobile phone or a personal digital assistant (PDA). The input unit 7800 may be, for example, a camera, in which case the occupant can input information by gesture. Alternatively, data obtained by detecting the motion of a wearable apparatus worn by the occupant may be input. Moreover, the input unit 7800 may include, for example, an input control circuit or the like that generates an input signal on the basis of information input by the occupant or the like using the above-described input unit 7800 and outputs the generated input signal to the integrated control unit 7600. By operating this input unit 7800, the occupant or the like inputs various types of data to the vehicle control system 7000 or instructs the vehicle control system 7000 on processing working.

The storage unit 7690 may include a read only memory (ROM) that stores various programs to be executed by the microcomputer, and a random access memory (RAM) that stores various parameters, computational results, sensor values, and the like. Furthermore, the storage unit 7690 may be implemented by a magnetic storage device such as a hard disc drive (HDD), a semiconductor storage device, an optical storage device, a magneto-optical storage device, or the like.

The general-purpose communication I/F 7620 is a communication I/F for general purposes that mediates communication with a variety of instruments present in an external environment 7750. The general-purpose communication I/F 7620 may be prepared with a cellular communication protocol such as global system of mobile communications (GSM) (registered trademark), WiMAX (registered trademark), long term evolution (LTE) (registered trademark), or LTE-Advanced (LTE-A), or other wireless communication protocols such as wireless LAN (also referred to as Wi-Fi (registered trademark)), or Bluetooth (registered trademark). The general-purpose communication I/F 7620 may connect to an instrument (for example, an application server or a control server) present on an external network (for example, the Internet, a cloud network, or a company's own network) via a base station or an access point, for example. Furthermore, the general-purpose communication I/F 7620 may use, for example, a peer-to-peer (P2P) technology to connect to a terminal present in the vicinity of the vehicle (for example, a terminal of the driver, a pedestrian, or a shop, or a machine type communication (MTC) terminal).

The dedicated communication I/F 7630 is a communication I/F supporting a communication protocol formulated for use in a vehicle. For example, the dedicated communication I/F 7630 can be prepared with a standard protocol such as wireless access in vehicle environment (WAVE) or dedicated short range communications (DSRC), which are a combination of the lower layer IEEE 802.11p and the upper layer IEEE 1609, or a cellular communication protocol. Typically, the dedicated communication I/F 7630 realizes vehicle-to-everything (V2X) communication, which is a concept including one or more of vehicle-to-vehicle communication, vehicle-to-infrastructure communication, vehicle-to-home communication, and vehicle-to-pedestrian communication.

For example, the positioning unit 7640 receives a global navigation satellite system (GNSS) signal from a GNSS satellite (for example, a global positioning system (GPS) signal from a GPS satellite) to execute positioning and generates position information including the latitude, longitude, and altitude of the vehicle. Note that the positioning unit 7640 may distinguish the current position by exchanging signals with a wireless access point or may acquire the position information from a terminal having a positioning function, such as a mobile phone, a personal handy-phone system (PHS), or a smartphone.

The beacon receiving unit 7650 receives, for example, radio waves or electromagnetic waves distributed from a wireless station or the like installed on the road and acquires information on the current position, congestion, road closure, required time, or the like. Note that the function of the beacon receiving unit 7650 may be included in the dedicated communication I/F 7630 described above.

The vehicle interior instrument I/F 7660 is a communication interface that mediates connection between the microcomputer 7610 and a variety of vehicle interior instruments 7760 present in the vehicle. The vehicle interior instrument I/F 7660 may establish a wireless connection using a wireless communication protocol such as wireless LAN, Bluetooth (registered trademark), near field communication (NFC), or wireless universal serial bus (WUSB). Furthermore, the vehicle interior instrument I/F 7660 may establish a wired connection such as a universal serial bus (USB), high-definition multimedia interface (HDMI) (registered trademark), or mobile high-definition link (MHL), via a connection terminal (not illustrated) (and a cable, if necessary). The vehicle interior instruments 7760 may include, for example, at least one of a mobile instrument or a wearable instrument carried by an occupant, or an information instrument brought in or mounted to the vehicle. In addition, the vehicle interior instruments 7760 may include a navigation apparatus that searches for a route to an arbitrary destination. The vehicle interior instrument I/F 7660 exchanges control signals or data signals with these vehicle interior instruments 7760.

The in-vehicle network I/F 7680 is an interface that mediates communication between the microcomputer 7610 and the communication network 7010. The in-vehicle network I/F 7680 transmits and receives signals and the like in compliance with a predetermined protocol supported by the communication network 7010.

The microcomputer 7610 of the integrated control unit 7600 controls the vehicle control system 7000 in accordance with various programs on the basis of information acquired via at least one of the general-purpose communication I/F 7620, the dedicated communication I/F 7630, the positioning unit 7640, the beacon receiving unit 7650, the vehicle interior instrument I/F 7660, or the in-vehicle network I/F 7680. For example, the microcomputer 7610 may compute a control target value for the driving force generating apparatus, the steering mechanism, or the braking apparatus on the basis of the acquired information inside and outside the vehicle, and output a control command to the drive system control unit 7100. For example, the microcomputer 7610 may perform coordinative control for the purpose of implementing the function of advanced driver assistance system (ADAS) including vehicle collision avoidance or impact mitigation, follow-up running based on inter-vehicle distance, vehicle speed maintenance running, vehicle collision warning, vehicle lane departure warning, or the like. Furthermore, the microcomputer 7610 may control the driving force generating apparatus, the steering mechanism, the braking apparatus, or the like on the basis of the acquired information around the vehicle so as to perform coordinative control for the purpose of, for example, the automatic driving in which the vehicle autonomously runs without depending on the operation by the driver, and other purposes.

On the basis of information acquired via at least one of the general-purpose communication I/F 7620, the dedicated communication I/F 7630, the positioning unit 7640, the beacon receiving unit 7650, the vehicle interior instrument I/F 7660, or the in-vehicle network I/F 7680, the microcomputer 7610 may generate three-dimensional distance information between the vehicle and a peripheral structure, an object such as a person, or the like, to create local map information including peripheral information on the current position of the vehicle. Furthermore, the microcomputer 7610 may generate a warning signal by predicting danger such as collision with a vehicle, a pedestrian or the like coming nearer, or entry into a road that is closed, on the basis of the acquired information. The warning signal may be, for example, a signal for generating a warning sound or for turning on a warning lamp.

The sound and image output unit 7670 transmits an output signal of at least one of a sound or an image to an output apparatus capable of visually or audibly notifying the occupant of the vehicle or the outside of the vehicle of information. In the example in FIG. 20, an audio speaker 7710, a display unit 7720, and an instrument panel 7730 are exemplified as output apparatuses. For example, the display unit 7720 may include at least one of an on-board display or a head-up display. The display unit 7720 may have an augmented reality (AR) display function. The output apparatus may be an apparatus other than the above-mentioned apparatuses, such as headphones, a wearable device such as a glasses-type display worn by the occupant, a projector, or a lamp. In a case where the output apparatus is a display apparatus, the display apparatus visually displays a result obtained by various processes performed by the microcomputer 7610 or information received from another control unit in a variety of formats such as text, image, table, or graph. Furthermore, in a case where the output apparatus is a sound output apparatus, the sound output apparatus converts an audio signal made up of reproduced sound data, acoustic data, or the like into an analog signal and audibly outputs the converted analog signal.

Note that, in the example illustrated in FIG. 20, at least two control units connected via the communication network 7010 may be unified as one control unit. Alternatively, each control unit may be constituted by a plurality of control units. Moreover, the vehicle control system 7000 may include another control unit not illustrated. Furthermore, in the above description, some or all of the functions allocated to one of the control units may be given to another control unit. In other words, as long as information is transmitted and received via the communication network 7010, a predetermined computational process may be performed by any one of the control units. Similarly, a sensor or an apparatus connected to one of the control units may be connected to another control unit and also a plurality of control units may transmit and receive detection information with each other via the communication network 7010.

In the vehicle control system 7000 described above, for example, the calibration processing unit 15, the weight setting unit 13, the parameter storage unit 14, and the parameter update unit 16 can be applied to the vehicle exterior information detecting unit 7400 of the application example illustrated in FIG. 20. Furthermore, the information acquisition unit 11-1 can be applied to the imaging unit 7410, and the information acquisition unit 11-2 can be applied to the vehicle exterior information detecting part 7420. In this manner, if the calibration apparatus of the present technology is provided in the vehicle control system 7000, a positional relationship between the plurality of imaging units, or the imaging units and the vehicle exterior information detecting parts can be precisely grasped, and the detection accuracy for peripheral objects can be enhanced. Therefore, for example, information required for lessening driver's fatigue and the like, for automatic driving, and the like can be acquired with higher accuracy.

The series of processes described in the description can be executed by hardware, software, or a complex configuration of both. In the case of executing the processes by software, a program recording a processing sequence is installed on a memory within a computer incorporated in dedicated hardware and executed. Alternatively, it is possible to install and execute the program on a general-purpose computer capable of executing various processes.

For example, the program can be recorded in advance on a hard disk, a solid state drive (SSD), or a read only memory (ROM) as a recording medium. Alternatively, the program can be temporarily or permanently saved and kept (recorded) on a removable recording medium such as a flexible disk, a compact disc read only memory (CD-ROM), a magneto-optical (MO) disk, a digital versatile disc (DVD), a Blu-Ray Disc (BD) (registered trademark), a magnetic disk, or a semiconductor memory card. Such a removable recording medium can be provided as so-called package software.

Furthermore, in addition to installing the program from a removable recording medium on a computer, the program may be wirelessly or wiredly transferred from a download site to a computer via a network such as a local area network (LAN) or the Internet. In the computer, it is possible to receive the program transferred in such a manner and to install the program on a recording medium such as a built-in hard disk.

Note that the effects described in the present description merely serve as examples and not construed to be limited. There may be an additional effect not described herein as well. Furthermore, the present technology should not be interpreted as being limited to the embodiments of the above-described technology. The embodiments of this technology disclose the present technology in the form of exemplification and it is self-evident that those skilled in the art can make modifications and substitutions of the embodiments without departing from the gist of the present technology. That is, in order to judge the gist of the present technology, claims should be considered.

In addition, the calibration apparatus of the present technology can also have the following configuration.

(1) A calibration apparatus including

a calibration processing unit that calculates parameters relating to positions and attitudes of a plurality of information acquisition units, using point cloud data relating to a feature point of a peripheral object generated on the basis of peripheral object information acquired by the plurality of information acquisition units, and a weight according to a situation between the peripheral object and the information acquisition units when the peripheral object information was acquired.

(2) The calibration apparatus according to (1), in which the calibration processing unit calculates a cost indicating an error of the parameters, using the point cloud data acquired for the feature point by the plurality of information acquisition units, the weight, and the parameters stored in advance, and calculates parameters that minimize the error, on the basis of the calculated cost.

(3) The calibration apparatus according to (2), in which the peripheral object information is acquired a plurality of times within a predetermined period.

(4) The calibration apparatus according to (3), in which the calibration processing unit sets the weight according to a moving speed of a moving body provided with the plurality of information acquisition units for each acquisition of the peripheral object information, and reduces the weight as the moving speed increases.

(5) The calibration apparatus according to (3) or (4), in which the calibration processing unit sets the weight according to a motion vector of the feature point, and reduces the weight as the motion vector increases.

(6) The calibration apparatus according to any one of (3) to (5), in which the predetermined period is a preset period from a start of movement of a moving body provided with the plurality of information acquisition units or a preset period until an end of movement of the moving body.

(7) The calibration apparatus according to any one of (2) to (6), in which the calibration processing unit sets the weight according to a distance from the plurality of information acquisition units to the feature point, and reduces the weight as the distance increases.

(8) The calibration apparatus according to any one of (2) to (7), further including a parameter update unit that updates the stored parameters using parameters calculated by the calibration processing unit.

(9) The calibration apparatus according to (8), in which the parameter update unit updates the parameters from when movement of a moving body provided with the plurality of information acquisition units is stopped or when movement of the moving body ends until when movement of the moving body starts next time.

(10) The calibration apparatus according to any one of (1) to (9), in which the plurality of information acquisition units each acquires at least a captured image of the peripheral object as the peripheral object information.

(11) The calibration apparatus according to (10), including, as the plurality of information acquisition units, an information acquisition unit that acquires a captured image of the peripheral object as the peripheral object information, and an information acquisition unit that quantifies a distance to each position of the peripheral object using a ranging sensor to treat a quantification result as the peripheral object information.

(12) The calibration apparatus according to (11), further including an information processing unit that performs a registration process on a quantification result for a distance to each position of the peripheral object acquired by the information acquisition unit, and generates point cloud data for each position of the peripheral object as point cloud data for each feature point.

(13) The calibration apparatus according to (10), including, as the plurality of information acquisition units, information acquisition units that each acquires a captured image of the peripheral object as the peripheral object information.

(14) The calibration apparatus according to (10), further including an information processing unit that performs feature point detection using a captured image of the peripheral object acquired by the information acquisition unit, and generates point cloud data for each feature point by a registration process for the detected feature point of the peripheral object.

### INDUSTRIAL APPLICABILITY

In a calibration apparatus, a calibration method, and a program according to this technology, parameters relating to positions and attitudes of a plurality of information acquisition units are calculated using point cloud data relating to a feature point of a peripheral object generated on the basis of peripheral object information acquired by the plurality of information acquisition units, and a weight according to a situation between the peripheral object and the information acquisition units when the peripheral object information was acquired. Therefore, the calibration is allowed to be performed stably. For this reason, it is suitable for an instrument that recognizes a peripheral object on the basis of information acquired by a plurality of information acquisition units, for example, an instrument such as an automobile or a flying body.

### REFERENCE SIGNS LIST

10 Calibration apparatus
11-1, 11-2, 11-2a Information acquisition unit
12-1, 12-2, 12-2a Information processing unit
13 Weight setting unit
14 Parameter storage unit
15 Calibration processing unit
16 Parameter update unit
131 Moving speed acquisition unit
132, 133, 136 Weight setting processing unit
134 Feature point holding unit
135 Motion vector calculation unit

1. A calibration apparatus comprising
a calibration processing unit that calculates parameters relating to positions and attitudes of a plurality of information acquisition units, using point cloud data relating to a feature point of a peripheral object generated on a basis of peripheral object information acquired by the plurality of information acquisition units, and a weight according to a situation between the peripheral object and the information acquisition units when the peripheral object information was acquired.

2. The calibration apparatus according to claim 1, wherein
the calibration processing unit calculates a cost indicating an error of the parameters, using the point cloud data acquired for the feature point by the plurality of information acquisition units, the weight, and the parameters stored in advance, and calculates parameters that minimize the error, on a basis of the calculated cost.

3. The calibration apparatus according to claim 2, wherein
the peripheral object information is acquired a plurality of times within a predetermined period.

4. The calibration apparatus according to claim 3, wherein
the calibration processing unit sets the weight according to a moving speed of a moving body provided with the plurality of information acquisition units for each acquisition of the peripheral object information, and reduces the weight as the moving speed increases.

5. The calibration apparatus according to claim 3, wherein
the calibration processing unit sets the weight according to a motion vector of the feature point, and reduces the weight as the motion vector increases.

6. The calibration apparatus according to claim 3, wherein
the predetermined period is a preset period from a start of movement of a moving body provided with the plurality of information acquisition units or a preset period until an end of movement of the moving body.

7. The calibration apparatus according to claim 2, wherein
the calibration processing unit sets the weight according to a distance from the plurality of information acquisition units to the feature point, and reduces the weight as the distance increases.

8. The calibration apparatus according to claim 2,
further comprising a parameter update unit that updates the stored parameters using parameters calculated by the calibration processing unit.

9. The calibration apparatus according to claim 8, wherein
the parameter update unit updates the parameters from when movement of a moving body provided with the plurality of information acquisition units is stopped or when movement of the moving body ends until when movement of the moving body starts next time.

10. The calibration apparatus according to claim 1, wherein
the plurality of information acquisition units each acquires at least a captured image of the peripheral object as the peripheral object information.

11. The calibration apparatus according to claim 10,
comprising, as the plurality of information acquisition units, an information acquisition unit that acquires a captured image of the peripheral object as the peripheral object information, and an information acquisition unit that quantifies a distance to each position of the peripheral object using a ranging sensor to treat a quantification result as the peripheral object information.

12. The calibration apparatus according to claim 11,
further comprising an information processing unit that performs a registration process on a quantification result for a distance to each position of the peripheral object acquired by the information acquisition unit, and generates point cloud data for each position of the peripheral object as point cloud data for each feature point.

13. The calibration apparatus according to claim 10,
comprising, as the plurality of information acquisition units, information acquisition units that each acquires a captured image of the peripheral object as the peripheral object information.

14. The calibration apparatus according to claim 10,
further comprising an information processing unit that performs feature point detection using a captured image of the peripheral object acquired by the information acquisition unit, and generates point cloud data for each feature point by a registration process for the detected feature point of the peripheral object.

15. A calibration method comprising
calculating, by a calibration processing unit, parameters relating to positions and attitudes of a plurality of information acquisition units, using point cloud data relating to a feature point of a peripheral object generated on a basis of peripheral object information acquired by the plurality of information acquisition units, and a weight according to a situation between the peripheral object and the information acquisition units when the peripheral object information was acquired.

16. A program for performing calibration on a computer,
the program causing the computer to execute:
a procedure of acquiring point cloud data relating to a feature point of a peripheral object generated on a basis of peripheral object information acquired by a plurality of information acquisition units; and
a procedure of calculating parameters relating to positions and attitudes of the plurality of information acquisition units, using a weight according to a situation between the peripheral object and the information acquisition units when the peripheral object information was acquired.
